(19) United States
(12) Patent Application Publication
(10) Pub. No.: US 2025/0356392 A1
(43) Pub. Date: Nov. 20, 2025

(54) AUTOMATED MANAGEMENT OF BRAND REPRESENTATION USING ARTIFICIAL INTELLIGENCE

(71) Applicant: Adobe Inc., San Jose, CA (US)

(72) Inventors: Anubhav Tripathi, Noida (IN); Rahul Gupta, Noida (IN); Prerna Bothra, Noida (IN); Mayank Gupta, Noida (IN); Kailash Chand Jakhar, Noida (IN); Ishika Goel, Noida (IN)

(21) Appl. No.: 18/665,157

(22) Filed: May 15, 2024

(51) Int. Cl. G06Q 30/0241

(52) U.S. Cl. CPC G06Q 30/0241

(57) ABSTRACT

Methods, computer systems, computer storage media, and graphical user interfaces are provided for facilitating management of brand representations. In one implementation, a set of brand guidelines associated with various guideline categories (e.g., text and imagebased guidelines) is obtained. Thereafter, a set of actionable guidelines is identified for the various guideline categories using an artificial intelligence model(s) (e.g., LLM). In accordance with obtaining brand-inclusive content associated with a brand, brand conformity data is generated, via the artificial intelligence model(s), to indicate an extent of conformity of the brand-inclusive content to at least one actionable guideline. Such brand conformity data can be provided for display to convey brand conformance of the brand-inclusive content.

### BACKGROUND

In the current digital world, entities often strive to generate and use content to reflect their brands by carefully crafting messaging and visuals that align with their brand identity and values. However, validating such created content aligns with the brand is a complex task, requiring deep understanding of the brand's guidelines and creative application across various platforms and contexts. Brand guidelines, including tone of voice, color schemes, and logos, serve as a foundation for content creation and validation in an effort to ensure consistency across various channels. Whether through social media, websites, advertisements, or blog posts, entities aim to convey a cohesive brand narrative that evokes emotions, builds trust, and establishes a unique brand personality. By maintaining this consistency and authenticity in their content, entities can effectively communicate their brand's story, values, and promises to connect with their audiences on a deeper level, ultimately driving brand loyalty and growth.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, facilitating automated management of brand representation or usage using artificial intelligence (AI), and more specifically generative AI. In particular, brand-inclusive content is evaluated for conformity to various brand guidelines in an automated manner. At a high level, embodiments described herein effectively and efficiently identify actionable guidelines for a brand and, thereafter, utilize the actionable guidelines to analyze or evaluate whether brand-inclusive content conforms to the actionable guidelines for the brand. In this regard, brand-inclusive content may be analyzed or evaluated in reference to desired or target actionable guidelines for a particular brand. In particular, brand-inclusive content may be analyzed in an automated manner (e.g., via a Large Language Model (LLM)) in reference to actionable guidelines to determine particular guidelines to which the brand-inclusive content complies, particular guidelines to which the brand-inclusive content is non-compliant, and/or actionable insights to indicate modifications that comply with the actionable guidelines. As can be appreciated, the actionable guidelines used for analysis of brand-inclusive content compliance may correspond with textual and/or visual aspects. In this way, textual and/or visual aspects associated with brand-inclusive content can be analyzed for compliance. Further, such a brand compliance analysis is performed using a most recent version of brand guidelines, thereby facilitating a more current and consistent brand usage analysis.

### BRIEF DESCRIPTION OF THE DRAWINGS

The technology described herein is described in detail below with reference to the attached drawing figures, wherein:

FIG. 1 is a block diagram of an exemplary system for management of brand representation, suitable for use in implementing aspects of the technology described herein;

FIG. 2 is an example implementation for facilitating management of brand representation, via a brand representation manager, in accordance with aspects of the technology described herein;

FIG. 3 provides an example prompt that may be generated via a guideline prompt generator, in accordance with aspects of the technology described herein;

FIG. 4 provides another example prompt that may be generated via a guideline prompt generator, in accordance with aspects of the technology described herein;

FIG. 5 provides an example of a set of desired images and a set of undesired images, in accordance with aspects described herein;

FIG. 6 provides an example prompt that includes a request to extract imagery and photography guidelines from provided images, in accordance with aspects of the technology described herein;

FIGS. 7A-7B provide examples of actionable guidelines, in accordance with aspects of the technology described herein;

FIG. 8A provides an example prompt generated to initiate brand usage evaluation in association with tone of voice guidelines, in accordance with aspects of the technology described herein;

FIG. 8B provides a response generated in response to the prompt provided in FIG. 8A in accordance with aspects of the technology described herein;

FIG. 9A provides an example prompt generated to initiate brand usage evaluation in association with logo usage guidelines, in accordance with aspects of the technology described herein;

FIG. 9B provides a response generated in response to the prompt provided in FIG. 9A in accordance with aspects of the technology described herein;

FIG. 10 provides one example of a single Hypertext Markup Language (HTML) node that represents an element, in accordance with embodiments described herein;

FIG. 11 provides an example of pseudo code for generating an overall Cascading Style Sheets (CSS) dictionary, in accordance with embodiments described herein;

FIG. 12 provides an example of a CSS dictionary in association with a single element, in accordance with embodiments described herein;

FIG. 13 provides one example pseudo code for traversing an HTML, in accordance with embodiments described herein;

FIG. 14 provides one example pseudo code for creating a JavaScript Object Notation (JSON) in association with leaf-level elements, in accordance with embodiments described herein;

FIG. 15A provides an example prompt generated to initiate brand usage evaluation in association with style guidelines, in accordance with embodiments described herein;

FIG. 15B provides an example prompt that includes HTML, JSON, and CSS dictionary for use in generating brand conformity data, in accordance with embodiments described herein;

FIG. 16 provides an example prompt generated to initiate brand usage evaluation in association with imagery guidelines, in accordance with embodiments described herein;

FIG. 17 provides an example prompt generated to initiate brand usage evaluation in association with design layout guidelines, in accordance with embodiments described herein;

FIGS. 18A-18C provide additional example responses that can be output from an AI model based on an input, in accordance with embodiments described herein;

FIGS. 19A-19C represent example user interfaces that may present various brand conformity data, in accordance with embodiments described herein;

FIG. 20 provides an example process flow, in accordance with embodiments described herein;

FIG. 21 provides an example method for facilitating management of brand usage, in accordance with embodiments described herein;

FIG. 22 provides another example method for facilitating management of brand usage, in accordance with embodiments described herein;

FIG. 23 provides another example method for facilitating management of brand usage, in accordance with embodiments described herein; and

FIG. 24 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### OVERVIEW

In today's business landscape, content is oftentimes created in association with a brand. For example, emails, portable document formats (PDFs), and websites can be created that incorporate a representation of a brand. A brand generally refers to a unique representation associated with an entity, such as a product, service, organization, or individual. Generally, effective branding includes creating a distinct identity that sets the entity apart from competitors as well as building trust and loyalty among customers. As customers develop a relationship and trust in association with a brand, it is valuable to have the brand be consistently represented in content. In this way, consistent brand representation may ensure individuals appropriately recognize and/or differentiate a brand.

Accordingly, brand guidelines may be generated in association with a brand for use in consistent representation of the brand. In particular, brand guidelines are generally generated or created to promote consistency in association with a brand throughout the content creation and publication process. In this regard, irrespective of an affiliation of a content creator, the brand guidelines can be used to provide guidance for consistent application of a brand representation included in the content.

Managing compliance with such brand guidelines in accordance with various brand-related content (e.g., created by external partners, vendors, and contractors), however, can be difficult and tedious. As one example, brand identity is complex. In particular, a brand may be represented by colors, logos, spacing, image choices, fonts, tonality, layouts, content themes, and/or the like. Validating such complex frameworks is time-consuming and often relies on human verification, which is costly and error-prone in validating full brand compliance. As another example, visual assets may be inconsistent. In particular, maintaining consistency in visual elements such as images, graphics, and multimedia content across various platforms poses a significant challenge. Further, scaling brand compliance validation exacerbates the difficulty and tediousness. As businesses grow, content creation associated therewith also may increase, for example, in relation to new partners. As such, the workload for brand compliance validation increases, making it challenging to maintain consistency across various channels and product ranges.

In some cases, brand guidelines are updated or modified. In this regard, managing brand compliance may be difficult to maintain in a timely manner. For instance, updating or revising brand guidelines may be a slow process. Implementing such modifications across a large volume of content requires substantial resources and is difficult to perform in a timely manner. As a result, brand consistency may decline during the brand guideline update process. Ensuring that various content aligns consistently and in a timely manner with brand guidelines, however, is crucial for a unified brand identity.

Current strategies for validating brand compliance largely rely on manual efforts, with brand managers interpreting aspects of the brand guidelines to verify compliance of brand-representative content. To do so effectively, content creators, marketers, copywriters, and/or managers require a comprehensive understanding and interpretation of brand guidelines, making sure the content created embodies the brand's unique identity, voice, and messaging. However, this approach is not only time-consuming and labor-intensive but also suffers from inconsistency due to the inherent subjectivity of individuals' interpretations of the guidelines. As such, manual validation of brand representations conforming to brand guidelines is labor-intensive, error-prone, and fails to capture the intricacies of distinct guidelines.

There have been attempts to analyze images and videos in association with brands using an analytics tool. Such conventional solutions, however, are focused on images and videos. As such, these solutions often fall short in producing brand conformity validation of a brand representation in its entirety and/or in a consistent manner. For example, using an analytics tool to analyze images and videos in association with a brand often fails to incorporate other aspects of content (e.g., text, layout, color, and typography), as well as the nuances of a brand's unique identity, which may result in content that does not comply with brand guidelines. Such an inconsistent application of brand guidelines may increase the risk of brand dilution and misrepresentation, which can undermine a brand's reputation and standing in the competitive market.

Moreover, unnecessary computing resources are utilized in performing brand conformance validation using conventional approaches. For example, computing and network resources are unnecessarily consumed to facilitate the labor-intensive process in reviewing and revising both manually generated and automatically generated content. For instance, computer input/output operations are unnecessarily increased in manually evaluating brand usage using a manual review and revision process to ensure the generated content complies with brand guidelines. Automated solutions similarly lack the ability to ensure that the generated content comports with brand guidelines. As such, computer input/output operations are unnecessarily increased in the process of reviewing content in an automated manner. For instance, when generated content is located in a disk array, there is unnecessary wear placed on the read/write head of the disk of the disk array each time the content is accessed, for instance, to revise the content. Even further, the review and revision process decreases the throughput for a network, increases the network latency, and increases packet generation costs when the information is located over a network.

As such, embodiments are generally directed to facilitating automated management of brand representation using AI (e.g., generative AI), such as a large language model(s) (LLM), a large vision model(s) (LVM), and/or a multimodal large language model(s) (MLLM). In particular, brand-inclusive content is evaluated for conformity to various brand guidelines in an automated manner. At a high level, embodiments described herein effectively and efficiently identify actionable guidelines for a brand and, thereafter, utilize the actionable guidelines to analyze or evaluate whether brand-inclusive content conforms to the actionable guidelines for the brand. In this regard, brand-inclusive content may be analyzed or evaluated in reference to desired or target actionable guidelines for a particular brand. In particular, brand-inclusive content may be analyzed in an automated manner (e.g., via an LLM) in reference to actionable guidelines to determine particular guidelines to which the brand-inclusive content complies, particular guidelines to which the brand-inclusive content is non-compliant, and/or actionable insights to indicate modifications that comply with the actionable guidelines. As can be appreciated, the actionable guidelines used for analysis of brand-inclusive content compliance may correspond with textual and/or visual aspects. In this way, textual and/or visual aspects associated with brand-inclusive content can be analyzed for compliance. Further, such a brand compliance analysis is performed using a most recent version of brand guidelines, thereby facilitating a more current and consistent brand usage analysis.

In operation, a user can provide a set of brand guidelines (e.g., in a document), and actionable guidelines can be extracted or identified therefrom. As described, an AI model may be used to extract actionable guidelines, for example, in association with various guideline categories, such as logo usage, color palette, typography, voice and tone, imagery, iconography, design layouts, etc. Upon extracting or identifying actionable guidelines, a user can input or provide brand-inclusive content associated with a brand and, based on the input, be automatically provided with brand conformity data. Brand-inclusive content generally refers to content associated with a particular brand. Generally, the brand-inclusive content is generated in a manner intended to convey representation of a brand. In accordance with obtaining the brand-inclusive content, a prompt can be generated that includes the brand-inclusive content, or a representation thereof, and actionable guidelines to use for evaluating the brand-inclusive content. Various representations of brand-inclusive content, such as representations in the format of HTML, HTML JSON, CSS, images or snapshots, etc., may be provided in the prompt to facilitate the evaluation. The particular type of brand-inclusive content representation used may vary depending on the guideline category being analyzed. Various guideline categories may include, for instance, voice and tone, logo usage, color palette, typography, imagery, design layout, etc.

In accordance with the prompt input to the AI model, such as an LLM, LVM, and/or MLLM, the model can output brand conformity data (e.g., associated with the guideline category being analyzed). Brand conformity data generally refers to any data indicating whether the brand-inclusive content conforms or complies with an actionable guideline(s). Brand conformity data may be presented, via a user interface, to a user to provide information regarding compliance to the brand. In some cases, the brand conformity data includes indications of attained actionable guidelines, indications of failed actionable guidelines, and/or actionable insights to suggest modifications to make to attain conformance with an actionable guideline(s).

Advantageously, conformity evaluation of brand-inclusive content can be performed in association with various types of brand guidelines, such as brand guidelines related to logo usage, color palette, typography, voice and tone, imagery, iconography, design layouts, etc. In this way, various text, images, and layouts are analyzed to identify whether the brand-inclusive content, or portions thereof, conform to the various types of brand guidelines. As such, a holistic approach can be used to analyze the brand-inclusive content for compliance with a desired representation of a brand.

Further, embodiments described herein provide a scalable, timely, and efficient solution. In particular, using AI techniques, such as an LLM, LVM, and/or MLLM, enables an efficient generation of brand conformity data that indicates conformity of brand-inclusive content with a brand. As a brand guideline modification(s) occurs, AI techniques may be used for timely accommodation for the modification(s) of the brand guideline. In this way, brand compliance is performed in a timely and consistent manner to account for any updates to a set of brand guidelines.

In addition, embodiments described herein provide an enhanced and intuitive user experience. In particular, in accordance with selecting to view brand conformity data, the user is presented with helpful and accurate brand conformity data. For example, various brand conformity data may indicate guidelines successfully attained by the content, guidelines unsuccessfully attained by the content, actionable insights or suggestions to improve or enhance the conformity of the content, a score indicating an extent of brand conformity, and/or the like. In this way, any brand compliance issues are identified and flagged and, further, actionable suggestions are provided to bring the content into adherence with the established brand standards.

Various terms are used throughout the description of embodiments provided herein. A brief overview of such terms and phrases is provided here for ease of understanding, but more details of these terms and phrases are provided throughout.

A brand generally refers to a unique representation associated with an entity, such as a product, service, organization, or individual.

A brand guideline generally refers to a rule or instruction that indicates how a brand should be represented, for example, visually and/or verbally. In this regard, brand guidelines are intended to ensure consistency in a brand's identity, messaging, and/or visual elements, regardless of where and how these components are displayed across various media channels.

An actionable guideline generally refers to a guideline or rule that can be analyzed by a computing device, or portion thereof, to determine compliance or conformity therewith. In embodiments, an actionable guideline is generated or extracted based on a brand guideline.

Brand-inclusive content generally refers to content that includes a representation of a brand. In this way, brand-inclusive content may be content generated in association with a brand in an effort to convey or indicate that the brand is consistent with a brand's identity. Brand-inclusive content may be in any of a number of formats, such as electronic mail, blog posts, websites, documents, etc.

Brand-inclusive content representation generally refers to a representation of brand-inclusive content. A representation of a brand-inclusive content may represent the entire content or a portion of the content. Brand-inclusive content representations may be in a number of formats, such as HTML, HTML JSON, CSS, a snapshot or image, etc.

A guideline category generally refers to a type of guideline used to indicate how a brand should be represented. Various examples of guideline categories include logo usage, color palette, typography, voice and tone, imagery, iconography, and design layout. Such guideline categories are provided as examples, and the technology described herein should not be limited to these example guideline categories.

Brand conformity data generally refers to data that indicates brand conformity. For instance, brand conformity data can indicate whether brand-inclusive content conforms to an actionable guideline(s). Examples of brand conformity data include an indication of whether an actionable guideline is attained, an indication of whether an actionable guideline is failed, an actionable insight, etc.

### Overview of Exemplary Environments for Facilitating Management of Brand Representations

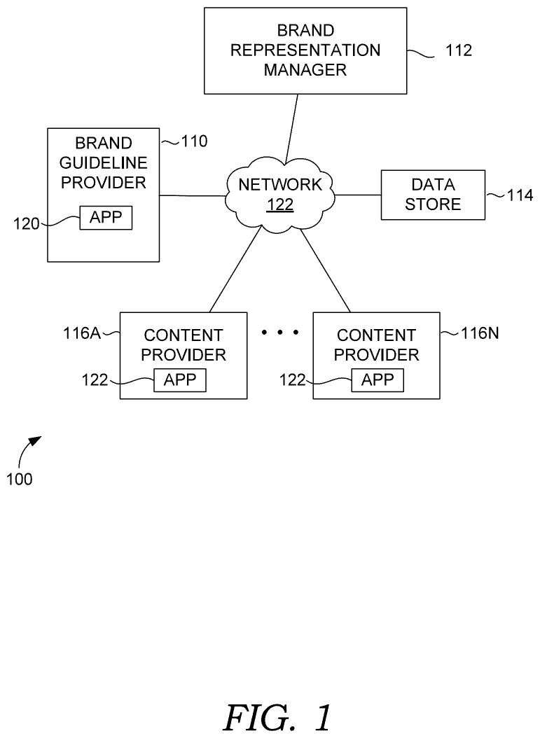

Referring initially to FIG. 1, a block diagram of an exemplary network environment 100 suitable for use in implementing embodiments described herein is shown. Generally, the system 100 illustrates an environment suitable for facilitating management of brand representations via AI (e.g., an LLM, LVM, and/or MLLM). Among other things, embodiments described herein effectively and efficiently identify actionable guidelines for a brand and, thereafter, utilize the actionable guidelines to analyze or evaluate whether brand-inclusive content conforms to the actionable guidelines for the brand. In this regard, brand-inclusive content may be analyzed or evaluated in reference to desired or target actionable guidelines for a particular brand. In particular, brand-inclusive content may be compared to actionable guidelines to determine particular guidelines to which the brand-inclusive content complies, particular guidelines to which the brand-inclusive content is non-compliant, and/or actionable insights to indicate modifications that comply with the actionable guidelines. As can be appreciated, the actionable guidelines used for analysis of brand-inclusive content compliance may correspond with textual and/or visual aspects. In this way, textual and/or visual aspects associated with brand-inclusive content can be analyzed for compliance. Further, such a brand compliance analysis is performed using a most recent version of brand guidelines, thereby facilitating a more current and consistent brand usage analysis.

In operation, a user, such as a marketer, can input or provide brand-inclusive content associated with a brand and, based on the input, be automatically provided with one or more brand conformity data. Brand-inclusive content generally refers to content associated with a particular brand. Generally, the brand-inclusive content is generated in a manner intended to convey representation of a brand. Brand conformity data generally refers to any data indicating whether the brand-inclusive content conforms or complies with an actionable guideline(s). Brand conformity data may be presented, via a user interface, to a user to provide information regarding compliance to the brand. In some cases, the brand conformity data includes indications of attained actionable guidelines, indications of failed actionable guidelines, and/or actionable insights to suggest modifications to make to attain conformance with an actionable guideline(s).

The network environment 100 includes a brand guideline provider 110, a brand representation manager 112, a data store 114, and content providers 116a-116n (referred to generally as content provider[s] 116). The brand guideline provider 110, the brand representation manager 112, the data store 114, and the content providers 116a-116n can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the brand guideline provider 110 and content providers 116a-116n may be in communication with the brand representation manager 112 via a mobile network or the Internet, and the brand representation manager 112 may be in communication with data store 114 via a local area network. Further, although the environment 100 is illustrated with a network, one or more of the components may directly communicate with one another, for example, via HDMI (high-definition multimedia interface) and DVI (digital visual interface). Alternatively, one or more components may be integrated with one another; for example, at least a portion of the brand representation manager 112 and/or data store 114 may be integrated with the brand guideline provider 110 and/or content provider 116. For instance, a portion of the brand representation manager 112 may be integrated with a server in communication with a brand guideline provider 110 and/or content provider 116, while another portion of the brand representation manager 112 may be integrated with the brand guideline provider 110 and/or content provider 116.

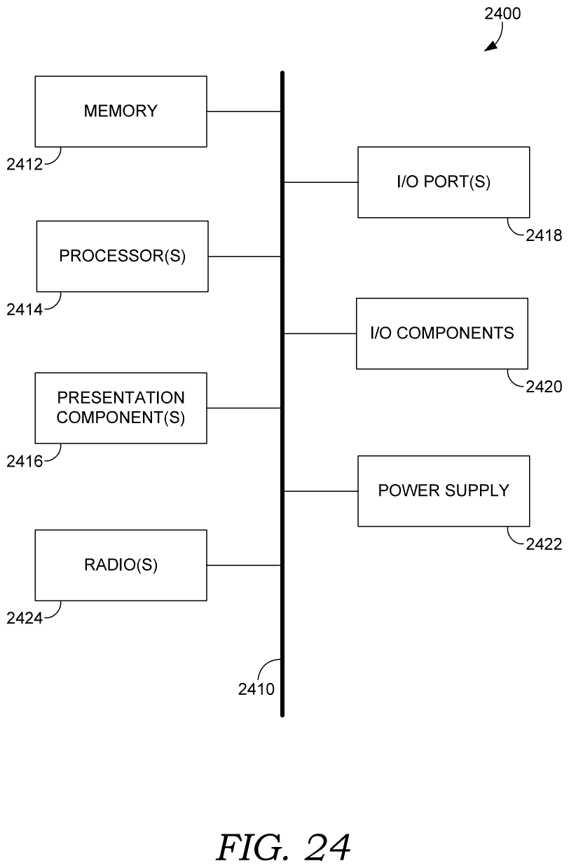

The brand guideline provider 110 and the content provider 116 can be any kind of computing device capable of facilitating management of brand representations. For example, in an embodiment, the brand guideline provider 110 and/or content provider 116 can be a computing device such as computing device 2400, as described above with reference to FIG. 24. In embodiments, the brand guideline provider 110 and/or content provider 116 can be a personal computer (PC), a laptop computer, a workstation, a mobile computing device, a personal digital assistant (PDA), a cell phone, or the like. Although illustrated separately, in some cases, the functionality described in association with the brand guideline provider 110 and the content provider 116 may be performed via a single device (e.g., the provider of the brand guidelines also provides the content).

The brand guideline provider 110 and/or content provider 116 can include one or more processors and one or more computer-readable media. The computer-readable media may include computer-readable instructions executable by the one or more processors. The instructions may be embodied by one or more applications, such as application 120 and/or application 122 shown in FIG. 1. The application(s) may generally be any application capable of facilitating management of brand representations. In some cases, the application(s), such as application 120, may facilitate providing brand guidelines for a brand in association with an entity (e.g., a company, a service, a product, an individual, etc.). Additionally or alternatively, the application(s), such as application 122, may facilitate providing brand-inclusive content and viewing brand conformity data in association therewith. In some implementations, the application(s) comprises a web application, which can run in a web browser, and could be hosted at least partially server-side (e.g., via brand representation manager 112). In addition, or instead, the application(s) can comprise a dedicated application. In some cases, the application is integrated into the operating system (e.g., as a service). As one specific example application, application 120 and/or application 122 may be a content management tool (e.g., Adobe® Experience Manager), or a portion thereof, that enables creation, management, and delivery of content and digital assets. In some cases, such digital experience may be provided across various channels, such as websites, mobile apps, forms, electronic communications, etc. Application 120 and/or 122 may be accessed via a mobile application, a web application, or the like. Application 120 and 122 may be the same application or different applications.

Brand guideline provider 110 and/or content provider 116 can be a client device on a client-side of operating environment 100, while brand representation manager 112 can be on a server-side of operating environment 100. Brand representation manager 112 may comprise server-side software designed to work in conjunction with client-side software on brand guideline provider 110 and/or content provider 116 so as to implement any combination of the features and functionalities discussed in the present disclosure. An example of such client-side software is application 120 on brand guideline provider 110. Another example of such client-side software is application 122 on content provider 116. This division of operating environment 100 is provided to illustrate one example of a suitable environment, and it is noted there is no requirement for each implementation that any combination of brand guideline provider 110, brand representation manager 112, and/or content provider 116 to remain as separate entities.

In an embodiment, the brand guideline provider 110 and/or content provider 116 is separate and distinct from the brand representation manager 112 and the data store 114 illustrated in FIG. 1. In another embodiment, the brand guideline provider 110 and/or content provider 116 is integrated with one or more illustrated components. For instance, the brand guideline provider 110 and/or content provider 116 may incorporate functionality described in relation to the brand representation manager 112. For clarity of explanation, embodiments are described herein in which the brand guideline provider 110, the brand representation manager 112, the data store 114, and the content providers 116 are separate, while understanding that this may not be the case in various configurations contemplated.

As described, a brand guideline provider, such as brand guideline provider 110, can facilitate providing a brand guideline(s) to brand representation manager 112. A brand guideline provider 110, as described herein, is generally operated by an individual or set of individuals that desires to provide brand guidelines for a brand for use in assessing conformance therewith. As can be appreciated, in some cases, such an individual need not be an individual associated with providing brand-inclusive content for which brand conformity is analyzed. For example, in some cases, a user providing a brand guideline(s) may be an individual or entity desiring to enforce or promote conformance for a particular brand. In many cases, a user providing a brand guideline(s) is an administrator or other individual representing a brand entity. In this way, an administrator user representing a brand entity provides brand guidelines for a brand, while a marketer user generating or analyzing content provides brand-inclusive content and views brand conformity data associated therewith. As described, the administrator user and the marketer user may correspond with or represent different entities, companies, or organizations.

In some cases, identification of actionable guidelines may be initiated at the brand guideline provider 110. For example, a user, such as an administrator or brand manager, may input, provide, or select a set of brand guidelines. For instance, a user may input or select, via a user interface, a set of brand guidelines associated with a brand. In some cases, a user may navigate to and select a document including brand guidelines for a brand or a set of brands and select to upload the document. The set of brand guidelines may include any type of guideline associated with a brand. Various examples of types of guidelines, or guideline categories, include logo usage, color palette, typography, voice and tone, imagery, iconography, and design layout, among others. Any number and combination of various guideline types may be included in a set of brand guidelines. For example, a first set of brand guidelines for a first brand may include brand logo usage, color palette, and typography guideline types, while a second set of brand guidelines for a second brand may include voice and tone, imagery, and iconography guideline types.

As can be appreciated, in some cases, an administrator, programmer, manager, or other individual affiliated with the brand may input or select a set of brand guidelines to use for analysis of brand-inclusive content created, for instance, by others, such as third-party content creators. In this way, a manager of a brand may provide brand guidelines in an effort to effectuate brand compliance of content generated by others. Alternatively or additionally, a user of the brand guideline provider 110 that may initiate the provision of a set of brand guidelines is a user that also provides brand-inclusive content to be analyzed. For example, an individual that is creating content in association with a brand may select or input brand guidelines for use in analyzing the brand-inclusive content created by the individual.

Although only a single brand guideline provider 110 is illustrated in FIG. 1, any number of brand guideline providers may operate in this environment. For example, a first brand guideline provider may provide brand guidelines in association with a first brand, while a second brand guideline provider may provide brand guidelines in association with a second brand.

An input or selection of brand guidelines can be provided via an application 120 operating on the brand guideline provider 110. In this regard, the brand guideline provider 110, via an application 120, might allow a user (e.g., an administrator) to input, select, or otherwise provide a set of brand guidelines. The application 120 may facilitate the inputting of brand guidelines in a verbal form, a textual input form, a document form, etc. Such brand guidelines may be input at the brand guideline provider 110 in any manner. For instance, upon accessing a particular application (e.g., a content management application), a user may be presented with, or navigate to, an input tool to input brand guidelines (e.g., via text input) and a corresponding brand. As another example, a user may navigate to and select a document that includes brand guidelines for a brand. Irrespective of a type of input, a user may provide various aspects including a brand identifier, various types of brand guidelines, a date, etc.

The brand guideline provider 110 can communicate with the brand representation manager 112 to provide brand guidelines. In embodiments, for example, a user may utilize the brand guideline provider 110 to provide a set of brand guidelines via the network 122. For instance, in some embodiments, the network 122 might be the Internet, and the brand guideline provider 110 interacts with the brand representation manager 112 to provide a set of brand guidelines for use in brand-inclusive content analysis. In other embodiments, for example, the network 122 might be an enterprise network associated with an organization. It should be apparent to those having skill in the relevant arts that any number of other implementation scenarios may be possible as well.

The content provider 116 is generally configured to provide brand-inclusive content to the brand representation manager 112 and, in response, view brand conformity data based on the analysis of the conformity of the brand-inclusive content to the corresponding brand guidelines. A content provider 116, as described herein, is generally operated by an individual or set of individuals that desires to evaluate or analyze brand-inclusive content for compliance with brand guidelines for a brand. In some cases, the content provider 116 may be the content creator or editor. In other cases, the content provider 116 may be affiliated with the brand and desires to ensure that third-party generated content complies with the brand guidelines. In this way, a user providing a brand guideline may be an individual desiring to enforce or promote conformance for a particular brand.

In some cases, brand usage evaluation may be initiated at the content provider 116. For example, a user, such as a content creator or marketer, may input, provide, or select brand-inclusive content. For instance, a user may input or select, via a user interface, content associated with a brand. In some cases, a user may navigate to and select a brand-inclusive document and select to upload the document. The brand-inclusive document may include any type of data, such as text, images, layouts, designs, etc.

As can be appreciated, in some cases, a user of the content provider 116 that may initiate brand usage evaluation is a user that also provides brand guidelines for use in performing the evaluation. For example, an individual that is creating content in association with a brand may also select or input brand guidelines for use in analyzing the brand-inclusive content created by the individual. Any number of content providers may operate in this environment. For example, a first content provider may provide a first brand-inclusive content, while a second content provider may provide a second brand-inclusive content.

An input or selection of content can be provided via an application 122 operating on the content provider 116. In this regard, the content provider 116, via an application 122, might allow a user to input, select, or otherwise provide brand-inclusive content. The application 122 may facilitate the inputting of content in a verbal form, a textual input form, a document form, etc. Such brand-inclusive content may be input at the content provider 116 in any manner. For instance, upon accessing a particular application (e.g., a content management application), a user may be presented with, or navigate to, an input tool to input content (e.g., via text input) and a corresponding brand. As another example, a user may navigate to and select a brand-inclusive document.

The content provider 116 can communicate with the brand representation manager 112 to provide content. In embodiments, for example, a user may utilize the content provider 116 to provide brand-inclusive content via the network 122. For instance, in some embodiments, the network 122 might be the Internet, and the content provider 116 interacts with the brand representation manager 112 to provide content for use in brand-inclusive content analysis. In other embodiments, for example, the network 122 might be an enterprise network associated with an organization. It should be apparent to those having skill in the relevant arts that any number of other implementation scenarios may be possible as well.

With continued reference to FIG. 1, the brand representation manager 112 can be implemented as server systems, program modules, virtual machines, components of a server or servers, networks, and the like. At a high level, the brand representation manager 112 manages representations of a brand. In this regard, the brand representation manager 112 analyzes brand usage to evaluate conformity to guidelines associated with the brand. In operation, and at a high level, the brand representation manager 112 can obtain a set of brand guidelines associated with a brand, for example, from brand guideline provider 110. Using AI models, such as an LLM, LVM, and/or MLLM, actionable guidelines may be generated based on the brand guidelines. Generally, actionable guidelines convert the brand guidelines into a guideline format that may be analyzed by a computing device, or portion thereof, to identify compliance therewith.

In accordance with generating actionable guidelines, the brand representation manager 112 can obtain brand-inclusive content from content provider 116. Thereafter, actionable guidelines corresponding with the brand-inclusive content may be obtained and used to analyze the brand-inclusive content for conformance with the actionable guidelines. In embodiments described herein, AI models, such as LLM, LVM, and/or MLLM, may be used to determine whether the brand-inclusive content, or portion thereof, complies or conforms to the actionable guidelines. In some cases, the model(s) may output brand-conforming data indicating conformity to the actionable guidelines, which may then be presented and/or used to present results via a user interface, for example, of the content provider 116.

Such data (e.g., actionable guidelines and/or brand conformity data) can additionally or alternatively be transmitted to data store 114 for access by brand representation manager 112. For example, in accordance with generating actionable guidelines, the guidelines may be stored for subsequent analysis or evaluation of brand-inclusive data.

Advantageously, utilizing implementations described herein enables evaluation of brand conformity of content to be performed in an efficient and accurate manner (e.g., in accordance with brand guidelines). Further, the brand conformity analysis can dynamically adapt to align with most recent brand guidelines (e.g., generated or updated for a brand). As such, a user can view brand conformity data and can assess the information accordingly. For example, a user, such as a content provider (e.g. marketer), may be presented with an indication of brand guidelines that are attained, an indication of brand guidelines that are not attained, an indication of actionable insights that, if performed, address unattained brand guidelines, and/or scores associated therewith.

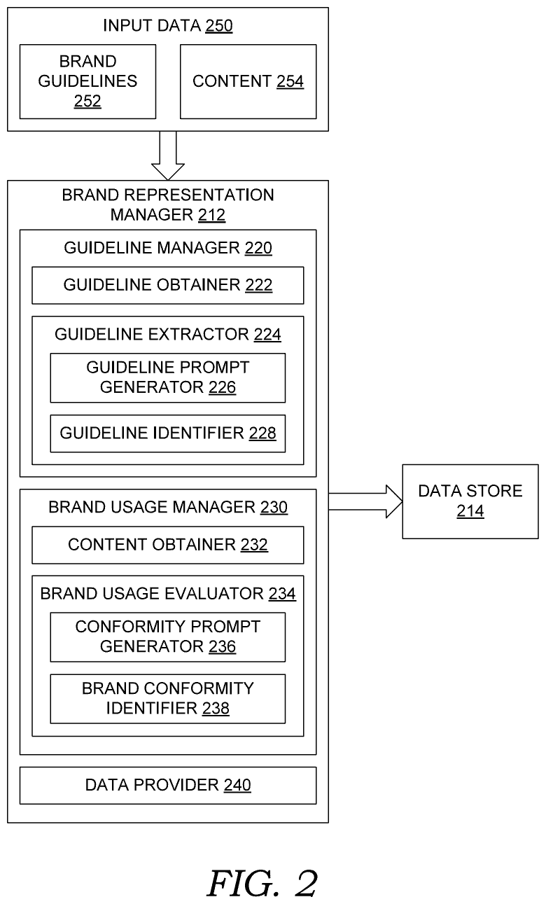

Turning now to FIG. 2, FIG. 2 illustrates an example implementation for facilitating management of brand representations via brand representation manager 212. The brand representation manager 212 can communicate with the data store 214. The data store 214 is configured to store various types of information accessible by the brand representation manager 212, or other server or component. In embodiments, brand guideline provider (such as brand guideline provider 110 of FIG. 1), content provider (such as content provider 116 of FIG. 1), and brand representation manager 212 can provide data to the data store 214 for storage, which may be retrieved or referenced by any such component. As such, the data store 214 may store brand guidelines, actionable guidelines, brand-inclusive content, brand conformity data, and/or the like.

In operation, the brand representation manager 212 is generally configured to manage brand representation. In particular, the brand representation manager 212 manages representations of brands, or brand usage, based on corresponding brand guidelines. In embodiments, the brand representation manager 212 includes a guideline manager 220, a brand usage manager 230, and a data provider 240. According to embodiments described herein, the brand representation manager 212 can include any number of other components not illustrated. In some embodiments, one or more of the illustrated components 220, 230, and 240 can be integrated into a single component or can be divided into a number of different components. Components 220, 230, and 240 can be implemented on any number of machines and can be integrated, as desired, with any number of other functionalities or services.

The guideline manager 220 is generally configured to manage guidelines. In this regard, the guideline manager may obtain brand guidelines, for example, from a brand guideline provider, and identify actionable guidelines for use in analyzing brand-inclusive content. The guideline manager 220 may execute in a variety of implementations. As one example, the guideline manager 220 may obtain brand guidelines and identify actionable guidelines in a real-time manner. That is, as a set of brand guidelines are obtained, actionable guidelines may be identified in real-time.

The guideline manager 220 may manage guidelines in any number of ways. In one example, the guideline manager 220 includes a guideline obtainer 222 and a guideline extractor 224. Any number of components may be used to manage guidelines, as described herein.

The guideline obtainer 222 is configured to obtain a set of brand guidelines. In this regard, the guideline obtainer 222 may obtain brand guidelines 252 as input data 250. As described, in some embodiments, brand guidelines may be obtained via a brand guideline provider, such as guideline provider 110 of FIG. 1. In this regard, a user may provide brand guidelines via a user interface of the brand guideline provider, which then provides the brand guidelines to the brand representation manager (e.g., via a network). In some cases, brand guidelines may be obtained during an onboarding process in association with the brand representation manager. In other cases, brand guidelines may be obtained based on input of brand guidelines as brand guidelines are generated, become available, are updated, etc.

In some cases, brand guidelines can be obtained from a data store, such as data store 214. For example, brand guidelines may be stored at data store 214 based on brand guidelines being provided by a brand guideline provider. Thereafter, the guideline obtainer 222 may obtain brand guidelines from the data store 214. For instance, the guideline obtainer 222 may obtain brand guidelines from the data store 214 (e.g., associated with a content management system) based on an input indicating to identify actionable guidelines and/or evaluate brand usage in association with a brand-inclusive content. In other instances, the guideline obtainer 222 may obtain brand guidelines from the data store 214 based on an occurrence of an event, such as expiration of a time duration. In this regard, brand guidelines may be obtained from a data store 214 in a periodic manner such that guidelines may be identified in a batch manner, at a downtime of the computing system, etc.

Brand guidelines, as used herein, generally refer to a set of rules and instructions that indicate how a brand should be represented, for example, visually and/or verbally. In this regard, brand guidelines are intended to ensure consistency in a brand's identity, messaging, and/or visual elements, regardless of where and how these components are displayed across various media channels. Brand guidelines may include detailed instructions on how to use various elements correctly and consistently in various materials, such as marketing materials, advertisements, websites, packaging, social media, blog posts, electronic messages, etc.

Brand guidelines may include rules, details, or instructions associated with various guideline types or categories. Particular guideline types or categories included in a set of brand guidelines for a brand may vary, depending on desires, goals, etc., associated with a brand. For instance, one set of brand guidelines for a brand may include one set of guideline types, while another set of brand guidelines for another brand may include another set of guidelines types.

Guideline categories or types may be in the form of visual and/or verbal formats to indicate desired visual elements and styles to increase brand recognition. Various examples of guideline categories include logo usage, color palette, typography, voice and tone, imagery, iconography, and design layout. Logo usage generally includes guidelines related to use of logos and may indicate, for example, proper logo placement, clear specifications on logo variations (e.g., primary, secondary, monochrome, etc.), minimum size, and clear space requirements. As one example, logo usage may specify “The logo should always be used in its primary color version, and it should never appear smaller than 0.75 inches in print or 100 pixels in digital media (for emails). Maintain a minimum clear space around the logo equal to the width of the ‘L’ in the logo.”

Color palette generally includes guidelines related to colors used in association with a brand. In this way, color palette guidelines may indicate primary and secondary brand colors with their Pantone; Cyan, Magenta, Yellow, and Key (CMYK); Red, Green, and Blue (RGB), and hexadecimal notation (HEX) values, guidelines for color combinations and usage, etc. Color palette may refer to various elements, such as buttons, headings, anchor-links, etc. As one example, a color palette guideline for a brand may specific “Primary brand colors are #0074D9 (blue) and #FF4136 (red). These colors should be used for all primary branding materials. Secondary colors can be used for accents and should be complementary to the primary colors.”

Typography guidelines generally include guidelines related to typefaces associated with a brand. In this way, typography guidelines may define primary and secondary typefaces, font sizes, line spacing, and usage guidelines for headlines, body text, and subheadings. As one example, a typography guideline for a brand may specify “Our primary typeface is ‘Roboto.’ Use it for all body text. ‘Montserrat’ can be used for headlines and subheadings. Headlines should be in 24 pt bold, while body text should be in 16 pt regular.”

Voice and tone guidelines generally include guidelines related to voice and tone associated with a brand. Voice and tone guidelines may indicate a personality and communication style associated with a brand, examples of tone for different scenarios (e.g., formal, casual, or empathetic), and/or the like. As one example, a voice and tone guideline for a brand may specify “Our brand is approachable and friendly. Use a casual tone in customer interactions. Maintain a professional tone in formal documents and emails.”

Imagery guidelines generally include guidelines related to images in association with a brand. Imagery guidelines may specify the types of images, illustrations, or icons that are consistent with the brand and/or offer guidance on image quality, style, and subject matter. As one example, an imagery guideline for a brand may specify “Use high-quality, original photography of our products in natural light. Avoid clichéd stock photos. Illustrations should be simple and reflect our brand's values.”

Iconography guidelines generally include guidelines related to iconography in association with a brand. Iconography guidelines may define the use of icons and symbols that represent the brand and/or specify guidelines for icon design and consistency. As one example, an iconography guideline for a brand may specify: “Our brand uses a signature ‘checkmark’ symbol to represent approval. Use this symbol in green (#00A896) or white (#FFFFFF) on a dark background.”

Design layout guidelines generally include guidelines related to a layout used in association with a brand. Design layout guidelines may indicate templates and rules for design layouts. As one example, a design layout guideline may specify that “A logo should appear at the top left corner of emails.” As another example, a design layout guideline may specify a single-column layout, double-column layout, or other multiple-column layout.

As described, a set of guidelines for a brand may include any combination of such guidelines. Further, other types of guidelines may be used, as the guideline types described herein are intended for illustrative purposes and are not intended to limit the scope of embodiments provided here.

The guideline extractor 224 is generally configured to extract actionable guidelines from the set of brand guidelines. An actionable guideline generally refers to a guideline or rule that can be analyzed by a computing device, or portion thereof, to determine compliance or conformity therewith. By way of example only, a set of brand guidelines may be created or generated in a manner for humans to read. The guideline extractor 224 may be used to identify and/or convert brand guidelines in a manner that is actionable by a computer. That is, the guideline extractor 224 may identify particular brand guidelines and convert the information to a format suitable for processing and/or analyzing by a computing device or system, or portion thereof (e.g., brand usage manager).

Guideline extraction may be performed in any number of ways. In some cases, a guideline extractor 224 may include a guideline prompt generator 226 and a guideline identifier 228. As can be appreciated, additional or alternative components may be used to extract actionable guidelines, in accordance with various embodiments described herein. In some cases, guideline extraction may be initiated automatically, for example, upon obtaining a set of brand guidelines, etc. In this way, in accordance with obtaining a set of brand guidelines, such as new guidelines or updated guidelines, guideline extraction may automatically occur such that a most recent version of the guidelines is extracted and available for analysis. In other cases, brand guideline extraction may be initiated based on a user request. For example, in accordance with a desire to analyze a brand-inclusive content, a user may select (e.g., via a prompt, link, menu, etc.) to initiate such an analysis. Such a selection indicating a preference to initiate an analysis or view brand conformity data can initiate or trigger the guideline extractor 224 to perform guideline extraction.

The guideline prompt generator 226 is generally configured to generate a guideline prompt that may be used to initiate guideline extraction. A guideline prompt generally refers to an input, such as an input text and/or graphic, that can be provided to a guideline identifier 228, such as an LLM, LVM, and/or MLLM, to generate an output in the form of actionable guidelines. In embodiments, the guideline prompt can include text to influence an AI model, such as an LLM and/or MLLM, to generate text having a desired content and structure. A prompt typically includes text given to an AI model to be completed. In this regard, a prompt generally includes instructions and, in some cases, data to use in performing the analysis. Additionally or alternatively, the guideline prompt may include images, or other non-text data, to influence an AI model, such as an LVM and/or MLLM, to generate an output having desired content and structure.

In accordance with embodiments described herein, a guideline prompt may include or reference various types of data. A guideline prompt may include, for example, an instruction or request, a guideline category(s) to extract actionable guidelines, and/or one or more brand guidelines. An instruction generally refers to a request for performing guideline extraction. For example, a guideline prompt may request to extract actionable guidelines from a provided brand guideline(s). A guideline category(s) (also referred to herein as a guideline type) may be included in the prompt to specify a particular guideline category or set of guideline categories to extract actionable guidelines. Any number or type of guideline categories may be included in a prompt. As described herein, in some cases, a separate guideline prompt may be generated for different guideline categories. In such a case, the guideline prompt includes an indication of a single guideline category. In other cases, a guideline prompt may request guideline extraction for multiple guideline categories and, as such, the guideline prompt includes an indication of multiple guideline categories. Although described as including a guideline category(s) in the prompt, in some cases, a guideline category(s) is not included. For instance, an instruction to extract any actionable guideline may be provided.

As described, a guideline prompt can also include or reference data, such as text data, corresponding to brand guidelines to generate an actionable guideline(s). In this way, brand guidelines obtained can be used as context to input into an AI model, such as an LLM, LVM, and/or MLLM. For example, an entire set of brand guidelines associated with a brand may be selected and included in a prompt as input to an LLM to generate an actionable guideline(s) for a brand. In some embodiments, an entire set of brand guidelines may be provided in a prompt in cases in which multiple guideline categories are indicated or a single guideline category is indicated for generating actionable brand guidelines. As another example, a portion of the brand guidelines associated with a brand may be selected and included in a prompt as input to an LLM to generate an actionable brand guideline(s) for a brand. In this way, in cases where a guideline prompt is generated in association with a particular guideline category, the corresponding brand guidelines may be selected to include in the prompt.

In embodiments, the brand guidelines are included in the prompt. In other embodiments, the brand guidelines are referenced in the prompt and/or provided along with the prompt for use in determining actionable guidelines therefrom.

As can be appreciated, in some embodiments, the guideline prompt may include additional or alternative input, such as output attributes or additional context. Output attributes generally indicate desired aspects associated with an output, such as actionable guidelines. For example, an output attribute may indicate a target temperature to be associated with the output. A temperature refers to a hyperparameter used to control the randomness of predictions. Generally, a low temperature makes the model more confident, while a higher temperature makes the model less confident. Stated differently, a higher temperature can result in more random output, which can be considered more creative. On the other hand, a lower temperature generally results in a more deterministic and focused output. A temperature may be a default value, a value based on user input, or a determined value. As another example, an output attribute may indicate a length of output. For example, a prompt may include an instruction for a desired number of paragraphs or sentences. As another example, a prompt may include an instruction for a maximum number of characters or a target range of characters. As another example, an output attribute may indicate a number of actionable guidelines to extract. As another example, an output attribute may indicate a target language for generating the output. For example, the text data may be provided in one language, and an output attribute may indicate to generate the output in another language. Any other instructions indicating a desired output are contemplated within embodiments of the present technology.

Additional context may include any additional information that provides context to the request. Additional context may include a day/time, an indication of a brand, a creator of brand guidelines, a user requesting the brand usage evaluation, etc. Any additional context may be provided to indicate brand guidelines to use, actionable guidelines to extract, etc.

As a guideline prompt may be specific to a particular set of brand guidelines or a specific guideline category, various prompts may be generated for use in identifying actionable guidelines associated with the various brand guidelines or guideline categories. For example, the guideline prompt generator 226 may generate a first prompt to identify actionable guidelines in association with logo usage, a second prompt to identify actionable guidelines in association with color palette, a third prompt to identify actionable guidelines in association with typography, and so on. In some cases, the guideline prompts may include a complete set of brand guidelines as context from which to generate the corresponding actionable guidelines. In other cases, the prompts may include a portion of the brand guidelines that correspond with the guideline category for which actionable guidelines are to be extracted.

In some embodiments, the guideline prompt generator 226 may be configured to select particular brand guidelines to use to generate the prompt. As one example, brand guidelines may be selected to be under a maximum number of tokens required by a guideline identifier, such as an LLM. For example, assume an LLM includes a 3,000-token limit. In such a case, text data totaling less than the 3,000-token limit may be selected. In this regard, prompts may have a size limit, thereby limiting the number of brand guidelines included in the prompt. As such, in some cases, using all brand guidelines may not be possible to be used as a prompt to an LLM due to size limitations of an LLM. Hence, it is necessary to select an optimal set of brand guidelines for feeding to the LLM for obtaining actionable guidelines. Although generally described as using tokens (e.g., pieces of words, individual sets of letters within words, spaces between words, and/or other natural language symbols or characters), for input size, as can be appreciated, other input sizes may be used and may not necessarily be based on token sequence length, but other data size parameters, such as bytes, number of words, etc.

Accordingly, in embodiments, the guideline prompt generator 226 may be configured to select the brand guidelines to include in a prompt to generate a data summary. To identify brand guidelines to include, any aspect or score may be used. For example, in some cases, a brand guideline score may be generated and used to selected brand guidelines. The score may represent an importance or value associated with the brand guideline. Such a score may indicate an extent or measure of some aspect for assessing optimal brand guidelines to include in the guideline prompt. For example, a score may indicate relevance to informativeness, diversity, and/or the like. In other cases, brand guidelines related to a selected or particular guideline category may be selected. For instance, in cases in which actionable guidelines associated with a particular guideline category are to be extracted, brand guidelines associated with the particular guideline category may be identified and used to generate the prompt.

The guideline prompt generator 226 may format the prompt in a particular form or data structure. One example of a data structure for a guideline prompt is as follows:

```
{ Instruction to generate actionable guidelines
{ Guideline category for which to generate actionable guidelines
{ Set of brand guidelines to use for generating actionable guidelines
  { Brand Guideline 1
    ...
  { Brand Guideline N
```

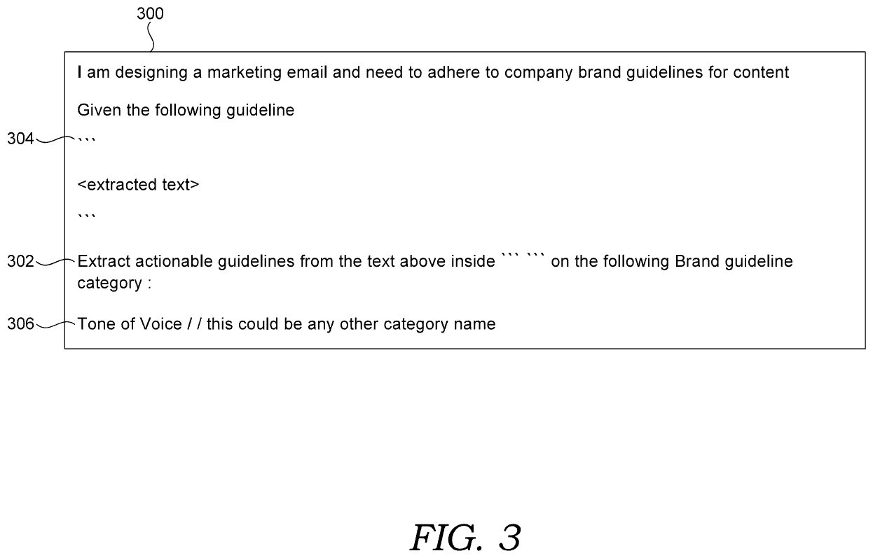

By way of example, and with reference to FIG. 3, FIG. 3 provides an example prompt that may be generated via the guideline prompt generator 226. The example prompt 300 includes a request 302 to extract actionable brand guidelines in association with provided brand guideline 304. In some cases, the provided brand guideline 304 includes all the brand guidelines associated with a brand. In other cases, the provided brand guideline 304 includes a portion of the brand guidelines associated with a brand. For instance, the brand guidelines selected may correspond with a particular guideline category for which actionable guidelines are to be identified (e.g., tone of voice). The example prompt 300 also includes an indication of the desired guideline category 306 for which actionable brand guidelines are to be identified. In this example, the guideline category 306 is specified as tone of voice. Using a particular guideline category for performing actionable guideline extraction or identification may enable a more detailed or complete result in relation to the particular guideline category. In other examples, however, alternative or additional guideline categories may be provided. For instance, in some cases, each guideline category may be specified to request actionable guidelines for various categories in a single shot. As another example, an indication to identify actionable brand guidelines in association with any guideline category may be provided.

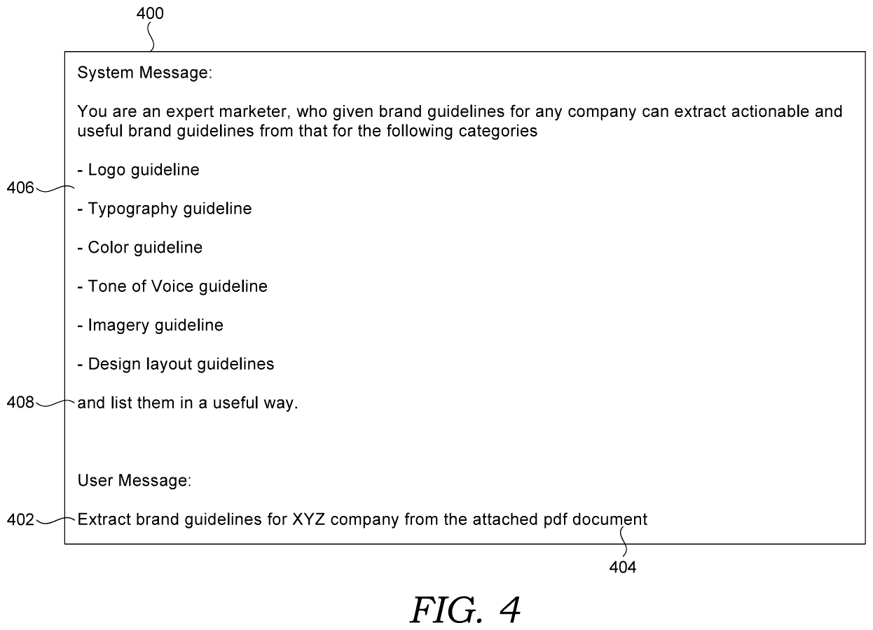

As another example, FIG. 4 provides another example prompt that may be generated via the guidance prompt generator 226. The example prompt 400 includes a request 402 to extract actionable brand guidelines in association with referenced set of brand guidelines 404. The example prompt 400 also includes an indication of a set of desired guideline categories 406 for which actionable guidelines are to be identified. In this example, the guideline categories 406 includes logo guidelines, typography guidelines, color guidelines, tone of voice guidelines, imagery guidelines, and design layout guidelines. The example prompt also requests the actionable guidelines be presented via a list in a useful way, as shown at 408.

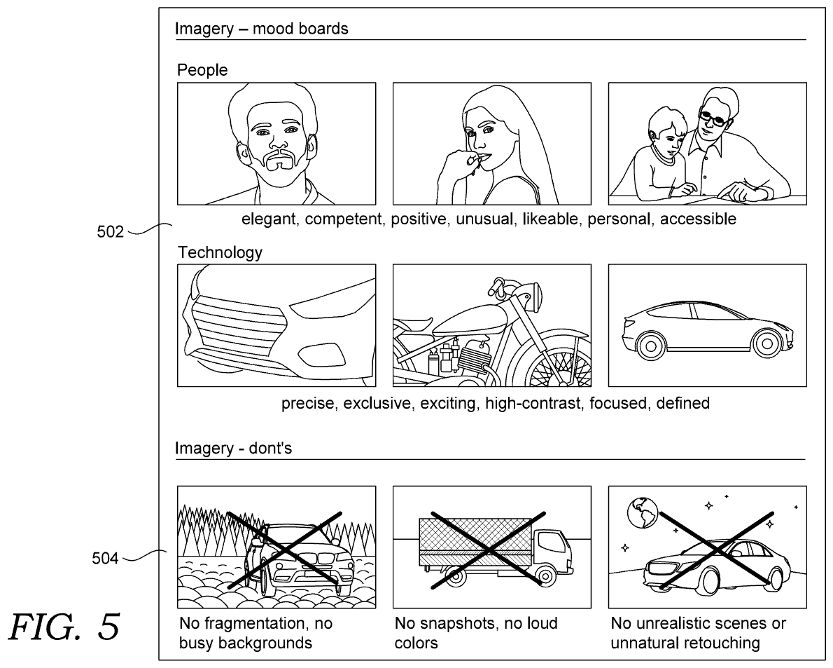

As described above, the guideline prompt generator 226 may use brand guidelines in the form of text as context input into a guideline prompt. In some cases, brand guidelines include images. For instance, brand guidelines for a brand may include a set of images that model or represent a desired image style and/or a set of images that model or represent an undesired image style. With reference to FIG. 5, FIG. 5 includes a set of desired images 502 and a set of undesired images 504.

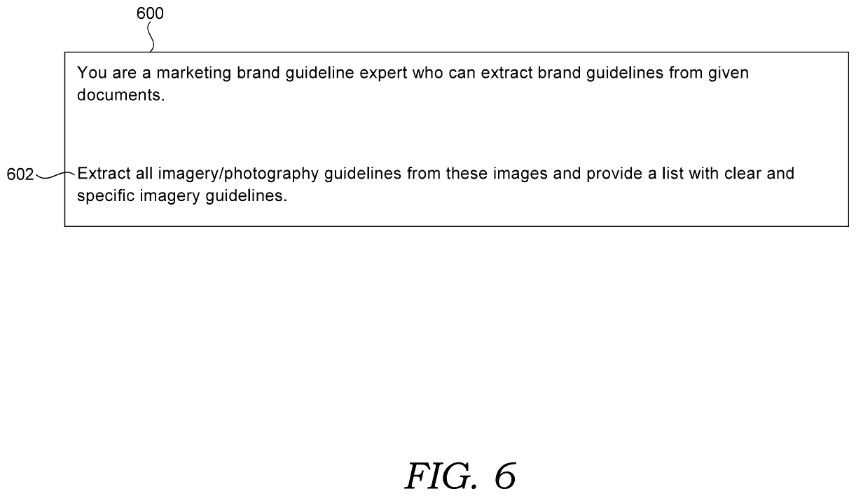

The images may be used in any number of ways to generate actionable guidelines. In some cases, the guideline prompt generator 226 may include text associated with the image(s) in the brand guidelines context provided in the prompt. For example, text captions or other text descriptions of the image(s) may be included in the guideline prompt. In other cases, the guideline prompt generator 226 may include an image(s) in the brand guidelines context provided in the prompt. The image(s) may be included in a guideline prompt along with other text brand guidelines. Additionally or alternatively, a separate guideline prompt may be generated for use in extracting or identifying actionable guidelines associated with the images. For instance, a guideline prompt specific to images, such as imagery guidelines and/or photography guidelines, may be generated to identify actionable guideline prompts related to images (e.g., via a vision model, such as Generative Pre-trained Transformer (GPT)-4 vision model). One example prompt is provided in FIG. 6. In FIG. 6, the guideline prompt 600 includes a request 602 to extract imagery and photography guidelines from provided images. The images may be included in the prompt or referenced via the prompt.

The guideline identifier 228 is generally configured to identify or extract actionable guidelines. In this regard, the guideline identifier 228 utilizes content (e.g., in the form of text and/or images) to generate actionable guidelines associated with a brand. In embodiments, the guideline identifier 228 takes, as input, a prompt or set of prompts generated by the guideline prompt generator 226. Based on the prompt, the guideline identifier 228 can generate a set of actionable guidelines, for example, associated with a brand indicated in the prompt. For instance, assume a prompt includes a set of brand guidelines associated with a brand. In such a case, the guideline prompt generator 226 identifies or generates actionable guidelines based on the set of brand guidelines included in the prompt.

As described, actionable guidelines generally refer to brand guidelines in an actionable form such that a computing component may determine conformity therewith. In embodiments, the actionable guidelines are provided as a set of rules (e.g., in the form of text) that can be used to determine whether brand-inclusive content conforms with the rules. Any number of actionable guidelines may be identified for any number of guideline categories.

The guideline identifier 228 may be or include any number of AI models or technologies (e.g., generative AI models or technologies). In some embodiments, the AI model is a Large Language Model (LLM). A language model is a statistical and probabilistic tool that determines the probability of a given sequence of words occurring in a sentence (e.g., via next sentence prediction [NSP] or minimal learning machine [MLM]). In this way, it is a tool that is trained to predict the next word in a sentence. A language model is called a large language model when it is trained on an enormous amount of data. Some examples of LLMs are OPT, FLAN-T5, BART, GOOGLE's BERT, and OpenAI's GPT-2, GPT-3, and GPT-4. For instance, GPT-3, is a large language model with 175 billion parameters trained on 570 gigabytes of text. These models have capabilities ranging from writing a simple essay to generating complex computer codes—all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities.

Additionally or alternatively, the guideline identifier 228 may be in the form of a large vision model (LVM) that can interpret and understand visual information. A visual model may be built using a deep learning technique, such as convolutional neural network (CNNs) and/or transformer models, which are well-suited for tasks involving image recognition, classification, segmentation, object detection, etc. At a high level, a vision model processes visual data in the form of images or videos, by extracting features at various levels of abstraction to understand the content. Vision models learn to recognize patterns, shapes, textures, and other visual cues that are relevant to a task. Examples of vision models include Landing AI's LandingLens and Google's Vision Transformer (ViT).

Further, the guideline identifier 228 may be in the form of a multimodal large language model (MLLM) that can interpret and understand visual information. An MLLM generally understands and generates text while also processing and comprehending other modalities, such as images, audio, and/or video. MLLM can associate text with various forms of data, thereby enabling such models to perform tasks that require understanding and synthesis across multiple modalities. Examples of MLLMs include Open AI's GPT-4 Turbo with Vision and Open AI's Contrastive Language-Image Pre-training (CLIP).

As such, as described herein, the guideline identifier 228, in the form of an LLM, LVM, and/or MLLM, can obtain a prompt and, using such information in the prompt, generate a set of actionable guideline(s) for a brand. In some embodiments, the guideline identifier(s) takes on the form of an LLM, LVM, and/or MLLM, but various other AI models can additionally or alternatively be used.

Use of LLM, LVM, and/or MLLM may depend on the format of a guideline prompt. As one example, guideline prompts including only text may be processed via an LLM, and guideline prompts including images may be processed via an LVM and/or MLLM. In some cases, text-based prompts and visual-based prompts may be generated separately such that the text-based prompts are processed by an LLM, while the visual-based prompts are processed via an LVM or MLLM. In other cases, prompts with a visual aspect may be directed to an MLLM. In this way, an MLLM may process both the text-based brand guidelines and the visual-based brand guidelines. Accordingly, although the guideline identifier 228 is illustrated as a single component, any number of components may be used to identify actionable guidelines.

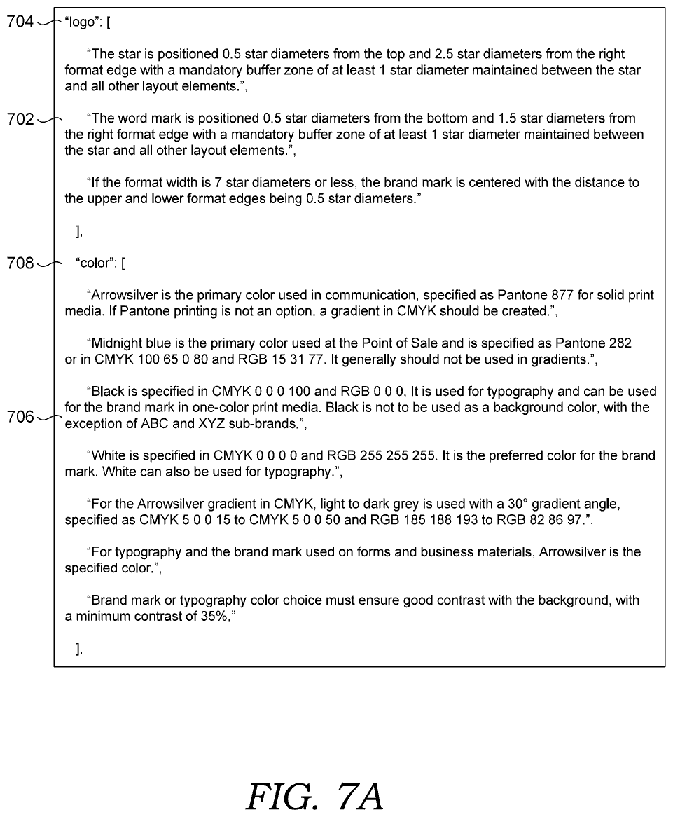

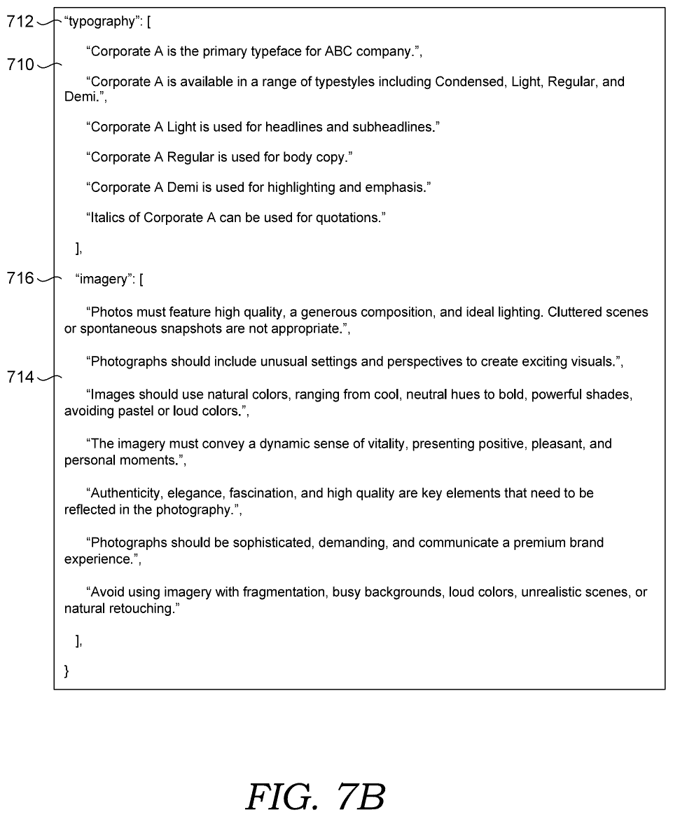

In accordance with the guideline identifier 228 identifying actionable guidelines, the actionable guidelines may be stored, for example, in data store 214, for use in performing subsequent brand usage evaluation. FIGS. 7A and 7B provide examples of actionable guidelines generated via one or more guideline identifiers 228. As shown in FIG. 7A, a set of actionable guidelines 702 are provided in association with logos 704, and a set of actionable guidelines 706 are provided in association with color 708. In FIG. 7B, a set of actionable guidelines 710 are provided in association with typography 712, and a set of actionable guidelines 714 are provided in association with imagery 716. In some cases, the actionable guidelines 714 may be generated from visual-based brand guidelines. That is, an LVM or MLLM may receive, as input, a prompt that includes one or more images, which may be used to generate actionable guidelines 712 in the form of text. For instance, by analyzing an image, the actionable guidelines 712 may be output via an LVM or MLLM as “Images should use natural colors, ranging from cool, neutral hues to bold, powerful shades, avoiding pastel or loud colors.”

The brand usage manager 230 is generally configured to manage usage of brand representations. In this regard, the brand usage manager 230 may analyze or evaluate use of a brand representation within brand-inclusive content. In particular, the brand usage manager 230 evaluates whether brand representation within content conforms with actionable guidelines associated with the brand. Although generally described herein as using actionable guidelines identified via guideline manager 220, in some cases, brand guidelines may be directly used to evaluate usage of brand representations. For example, the brand usage manager 230 may obtain brand guidelines (e.g., from a brand guideline provider), which may then be used to evaluate use of a brand representation within brand-inclusive content.

The content obtainer 232 is configured to obtain brand-inclusive content. In this regard, the content obtainer 232 may obtain content 254 as input data 250. Brand-inclusive content generally refers to content that includes a representation of a brand. As described, in some embodiments, brand-inclusive content may be obtained via a content provider, such as content provider 116 of FIG. 1. In this regard, a user may provide brand-inclusive content via a user interface of the content provider, which then provides the brand-inclusive content to the brand representation manager (e.g., via a network). In some cases, brand-inclusive content may be obtained as brand-inclusive content is created, generated, and/or updated. For instance, in association with generating a version of brand-inclusive content, the brand-inclusive content can be obtained. In other cases, brand-inclusive content may be obtained based on a request to evaluate the content for brand conformity, etc. For instance, a manager of a brand may request to evaluate various brand-inclusive content for conformance with the brand.

In some cases, brand-inclusive content can be obtained from a data store, such as data store 214. For example, brand-inclusive content may be stored at data store 214 based on content being provided by a content provider. Thereafter, the content obtainer 232 may obtain brand-inclusive content from the data store 214. For instance, the content obtainer 232 may obtain brand-inclusive content from the data store 214 (e.g., associated with a content management system) based on an input indicating to analyze or evaluate brand usage in association with a brand-inclusive content. In other instances, the content obtainer 232 may obtain brand-inclusive content from the data store 214 based on an occurrence of an event, such as expiration of a time duration. In this regard, brand-inclusive content may be obtained from a data store 214 in a periodic manner such that content may be analyzed for brand conformance in a batch manner, at a downtime of the computing system, etc.

The brand usage evaluator 234 is configured to use the actionable guidelines to evaluate content. Generally, brand-inclusive content evaluation is performed to identify brand conformity data. Brand conformity data generally refers to data indicating whether brand-inclusive content conforms to an actionable guideline(s). Brand conformity analysis may be performed in any number of ways. In some cases, a brand usage evaluator 234 may include a conformity prompt generator 236 and a brand conformity identifier 238. As can be appreciated, additional or alternative components may be used to evaluate brand-inclusive content, in accordance with various embodiments described herein. In some cases, brand usage evaluation may be initiated automatically, for example, upon obtaining brand-inclusive content. In this way, in accordance with obtaining brand-inclusive content, such as new brand-inclusive content or updated content, brand usage evaluation may occur. In other cases, brand usage evaluation may be initiated based on a user request. For example, in accordance with a desire to analyze a brand-inclusive content, a user may select (e.g., via a prompt, link, menu, etc.) to initiate such an analysis. Such a selection indicating a preference to initiate an analysis or view brand conformity data can initiate or trigger the brand usage evaluator 234 to perform brand usage evaluation.

The conformity prompt generator 236 is generally configured to generate a conformity prompt that may be used to initiate brand usage evaluation. A conformity prompt generally refers to an input, such as an input text and/or graphic, that can be provided to a brand conformity identifier 238, such as an LLM, LVM and/or MLLM, to generate an output in the form of brand conformity data. In embodiments, the conformity prompt can include text and/or images to influence an AI model, such as an LLM, LVM, and/or MLLM, to generate desired content and structure. A prompt typically includes text given to an AI model to be completed and/or an image to be evaluated. In this regard, a prompt generally includes instructions and, in some cases, data to use in performing the analysis.

In accordance with embodiments described herein, a conformity prompt may include or reference various types of data. A conformity prompt may include, for example, an evaluation instruction or request, an indication of a guideline category to analyze, a set of actionable guidelines, and/or brand-inclusive content. An evaluation instruction generally refers to a request for performing brand usage evaluation or conformity analysis. For example, a conformity prompt may request to analyze brand-inclusive content in accordance with actionable guidelines. An indication of a guideline category(s) may be included in the prompt to specify a particular guideline category or set of guideline categories to evaluate brand usage. Any number or type of guideline categories may be included in a prompt. As described herein, in some cases, a separate guideline prompt may be generated for different guideline categories. In such a case, the guideline prompt includes an indication of a single guideline category. In other cases, a guideline prompt may request brand usage evaluation for multiple guideline categories and, as such, the conformity prompt includes an indication of multiple guideline categories.

As described, a guideline prompt can also include or reference data corresponding to actionable guidelines to generate brand conformity data. In this way, actionable guidelines can be used as context provided to an AI model. For example, an entire set of actionable brand guidelines associated with a brand may be selected and included in a prompt as input to an LLM, LVM, and/or MLLM to generate brand conformity data for a brand. In embodiments, an entire set of actionable guidelines may be provided in cases in which multiple guideline categories are indicated or a single guideline category is indicated for generating brand conformity data. As another example, a portion of the actionable brand guidelines associated with a brand may be selected and included in a prompt as input to an LLM, LVM, and/or MLLM to generate brand conformity data for a brand. In this way, in cases in which a conformity prompt is generated in association with a particular guideline category, the corresponding actionable guidelines may be indicated in the prompt. Although described as including actionable guidelines in the prompt, in some cases, actionable guidelines are not included. For example, actionable guidelines may be referenced in the prompt and/or provided along with the prompt for use in determining brand conformity data therefrom.

In some cases, the suitable actionable guidelines to include in a prompt are obtained from the guideline manager 220 and/or data store 214. In this way, the actionable guidelines may be referenced or obtained for use in the conformity prompt. As one example, assume a conformity prompt is being generated to identify conformance associated with a particular guideline category, such as color palette. In such a case, the actionable guidelines related to color palette, for example, as identified via guideline identifier 228, may be obtained and used to generate the conformity prompt.

A conformity prompt may also include or reference brand-inclusive content, and/or a representation thereof. As described, the brand-inclusive content refers to the content including a brand representation. For example, a brand-inclusive content may be in the form of a document, an electronic message, a website, a blog post, etc. A representation of a brand-inclusive content may be any representation of brand-inclusive content. A brand-inclusive content representation may be in various forms. As examples, a brand-inclusive content representation may be a portion of brand-inclusive content, Hypertext Markup Language (HTML) associated with the brand-inclusive content, a snapshot or image of the brand-inclusive content, HTML JavaScript Object Notation (JSON) associated with the brand-inclusive content, a cascading style sheet(s) (CSS) associated with the brand-inclusive content, and/or the like. Various brand-inclusive content representations may be included in a prompt. In some cases, a particular brand-inclusive content and/or representation thereof to include in a prompt may vary based on a guideline category, a design preference, etc., some examples of which are provided herein.

As can be appreciated, in some embodiments, the conformity prompt may include output attributes or additional context. Output attributes generally indicate desired aspects associated with an output, such as brand conformity data. For example, an output attribute may indicate a target temperature to be associated with the output. As another example, an output attribute may indicate a length of output. For example, a prompt may include an instruction for a desired number of paragraphs or sentences. As another example, a prompt may include an instruction for a maximum number of characters or a target range of characters. As another example, an output attribute may indicate a number of brand conformity data aspects to include as output. As another example, an output attribute may indicate a target language for generating the output. For example, the text data may be provided in one language, and an output attribute may indicate to generate the output in another language. Any other instructions indicating a desired output are contemplated within embodiments of the present technology.

As yet another example, an output attribute may indicate a type of brand conformity data to output. Brand conformity data may be any type of data that indicates brand conformity. One example of brand conformity data includes an indication of whether a brand representation conforms or complies with an actionable brand guideline or set of guidelines. Stated differently, brand conformity data may indicate actionable brand guidelines being followed and actionable brand guidelines being violated. Another example of brand conformity data includes an indication of a recommendation or suggestion of an actionable insight. An actionable insight generally refers to an action that, if taken, can effectuate conformance with an actionable guideline. Another example of brand conformity data includes a category compliance score or brand compliance score. A category compliance score refers to a measure or extent of compliance with a particular guidance category, and a brand compliance score refers to a measure or extent of compliance with a brand (e.g., based on aggregate or average category compliance scores).

Additional context may include any additional information that provides context to the request. Additional context may include a day/time, an indication of a brand, a creator of brand-inclusive content, a user requesting the brand usage evaluation, etc. Any additional context may be provided to indicate actionable brand guidelines to use, brand usage evaluation to perform, etc.

As a conformity prompt may be specific to a particular set of actionable guidelines or a specific guideline category, various prompts may be generated for use in generating brand conformity data associated with the various actionable guidelines or guideline categories. For example, the conformity prompt generator 236 may generate a first prompt to generate brand conformity data in association with logo usage, a second prompt to generate brand conformity data in association with color palette, a third prompt to generate brand conformity data in association with typography, and so on. In some cases, the prompts may include a complete set of actionable guidelines as context from which to generate the brand conformity data. In other cases, the prompts may include a portion of the actionable guidelines that correspond with the guideline category for which brand conformity data is to be generated.

In some embodiments, the conformity prompt generator 226 may be configured to select particular actionable guidelines and/or brand-inclusive content to use to generate the prompt. As one example, data may be selected to be under a maximum number of tokens required by a brand conformity identifier, such as an LLM, LVM, and/or MLLM. For example, assume an LLM includes a 3,000-token limit. In such a case, text data totaling less than the 3,000-token limit may be selected. In this regard, prompts may have a size limit, thereby limiting the number of brand guidelines included in the prompt. As such, in some cases, using all actionable guidelines and/or brand-inclusive content may not be possible to be used as a prompt to an LLM due to size limitations of an LLM. Hence, it is necessary to select an optimal set of actionable guidelines and/or brand-inclusive content, or representation(s) thereof, for feeding to the LLM for obtaining brand conformity data. Although generally described as using tokens (e.g., pieces of words, individual sets of letters within words, spaces between words, and/or other natural language symbols or characters), for input size, as can be appreciated, other input sizes may be used and not necessarily be based on token sequence length, but other data size parameters, such as bytes, number of words, etc.

Accordingly, in embodiments, the conformity prompt generator 236 may be configured to select the actionable guidelines and/or brand-inclusive content, or representation(s) thereof, to include in a prompt to generate brand conformity data. To identify data to include, any aspect or score may be used. For example, in some cases, a score may represent an importance or value associated with an actionable guideline and/or brand-inclusive content. As another example, a score may indicate relevance to informativeness, diversity, and/or the like. In other cases, actionable guidelines related to a selected or particular guideline category may be selected. For instance, in cases in which actionable guidelines associated with a particular guideline category are evaluated, actionable guidelines associated with the particular guideline category may be identified and used to generate the prompt.

The conformity prompt generator 236 may format the prompt in a particular form or data structure. One example of a data structure for a conformity prompt is as follows:

```
{ Instruction to generate brand conformity data
{ Guideline category for which to generate brand conformity data
{ Set of actionable guidelines to use for generating brand conformity data
  { Actionable Guideline 1
    ...
  { Actionable Guideline 2
{ Brand-inclusive content, or representation(s) thereof
```

As described, prompt generation may vary. For example, in some cases, a conformity prompt may be generated in association with a particular guideline category being analyzed. In this regard, the conformity prompt generator 236 may identify a particular guideline category and, based on the guideline category, obtain the suitable content to include in the conformity prompt. At a high level, and as described, the conformity prompt requests brand conformity data for brand-inclusive content, or a representation thereof, based on actionable guidelines. Various examples of conformity prompts that may be generated based on various guideline categories are provided herein.

In one embodiment, a conformity prompt may be generated to evaluate conformance with tone of voice actionable guidelines. In this way, the conformity prompt generator 236 may obtain the tone of voice actionable guidelines (e.g., via the guideline manager and/or data store 214). In addition, text-based brand-inclusive content may also be obtained. Text-based brand-inclusive content may include an entire content or a portion of the content. As one example, text content of an electronic message may be extracted and used as context in the conformity prompt. Such actionable guidelines and brand-inclusive content may be included as context in the conformity prompt. The conformity prompt may also include an instruction to generate brand conformity data in a format that includes a score for the tone of voice category, an indication of guidelines violated, an indication of guidelines attained, and actionable insights. In some cases, instructions for generating a score may be provided. For instance, an instruction may specify to generate a score between 0 and 10, with 10 indicating all guidelines are followed. As the context is provided in text form, such a conformity prompt may be provided to an LLM for brand usage evaluation.

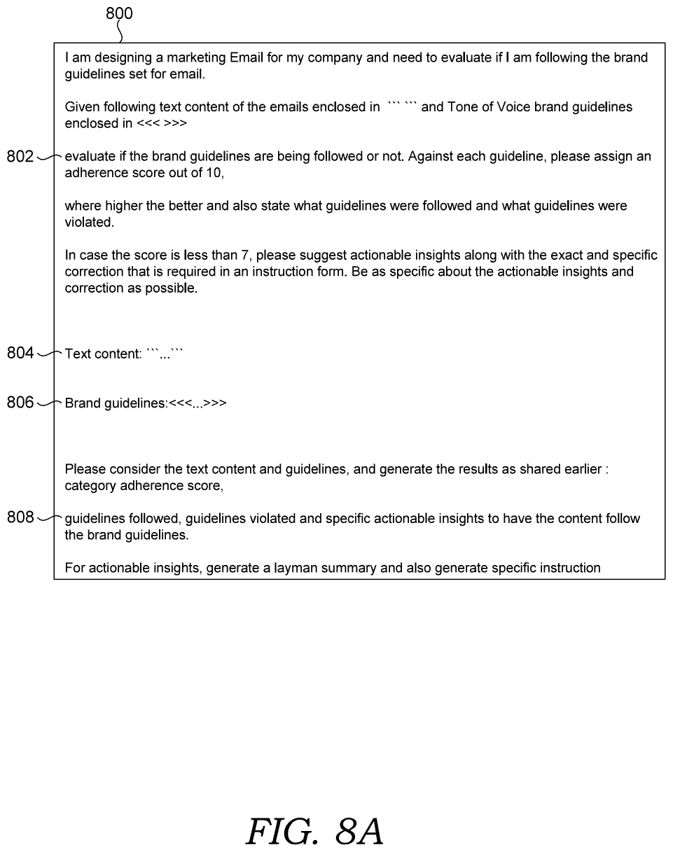

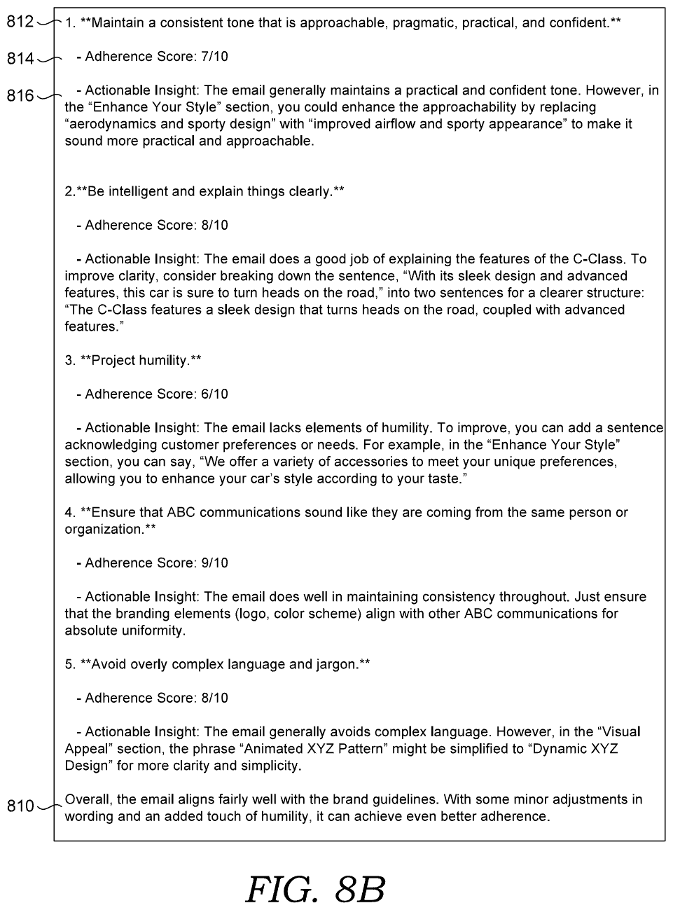

By way of example, and with reference to FIG. 8A, FIG. 8A provides an example prompt 800 generated to initiate brand usage evaluation in association with tone of voice guidelines. The example prompt 800 includes an instruction 802 to perform brand usage evaluation given brand-inclusive content 804 in light of actionable guidelines 806. Instructions 808 related to desired brand conformance data is also provided in the prompt.

In one embodiment, a conformity prompt may be generated to evaluate conformance with logo usage actionable guidelines. In this way, the conformity prompt generator 236 may obtain the logo usage actionable guidelines (e.g., via the guideline manager and/or data store 214). In addition, brand-inclusive content, or a representation thereof, may also be obtained. The brand-inclusive content may be the entirety of the content, such as an electronic message, document, etc., or a portion thereof. A representation of brand-inclusive content may represent an entire content or a portion of the content. As one example, a brand-inclusive content representation may include a representation of a relevant part of the content. For example, a portion of the content in which a logo appears may be obtained and used as context in the conformity prompt. Such a portion of the content may be represented via an image or HTML. For example, logo HTML that includes HTML code used to display a logo may be used. Additionally or alternatively, a brand-inclusive content representation may include a set of design details. A set of design details may be in the form of CSS. CSS is a style sheet language used to define presentation and styling of HTML elements. CSS may control attributes, such as colors, fonts, spacing, layout, and other visual aspects. In some embodiments, design details and/or HTML associated with the entire brand-inclusive content may be obtained and used. In other embodiments, design details and/or HTML associated with the portion of the content in which the logo appears may be obtained and used. In some cases, the brand-inclusive content can be used to provide context in association with the design details and/or HTML (e.g., where a logo is placed in context of entire brand-inclusive content). Design details and/or HTML can be valuable as logo usage actionable guidelines may include rules associated with logo size, color, orientation, alignment, etc. As such, including design details (e.g., in the form of CSS) and/or HTML in the prompt enables such guidelines to be evaluated for conformance.

Such actionable guidelines and brand-inclusive content, or representations thereof, may be included as context in the conformity prompt. The conformity prompt may also include an instruction to generate brand conformity data in a format that includes a score for the logo usage category, an indication of guidelines violated, an indication of guidelines conformed, and actionable insights. In some cases, instructions for generating a score may be provided. For instance, an instruction may specify to generate a score between 0 and 10, with 10 indicating all guidelines are followed. In cases in which the context is provided in text form, such a conformity prompt may be provided to an LLM for brand usage evaluation. In cases in which the context includes an image (e.g., a snapshot of the logo), such a conformity prompt may be provided to an LVM and/or MLLM for brand usage evaluation.

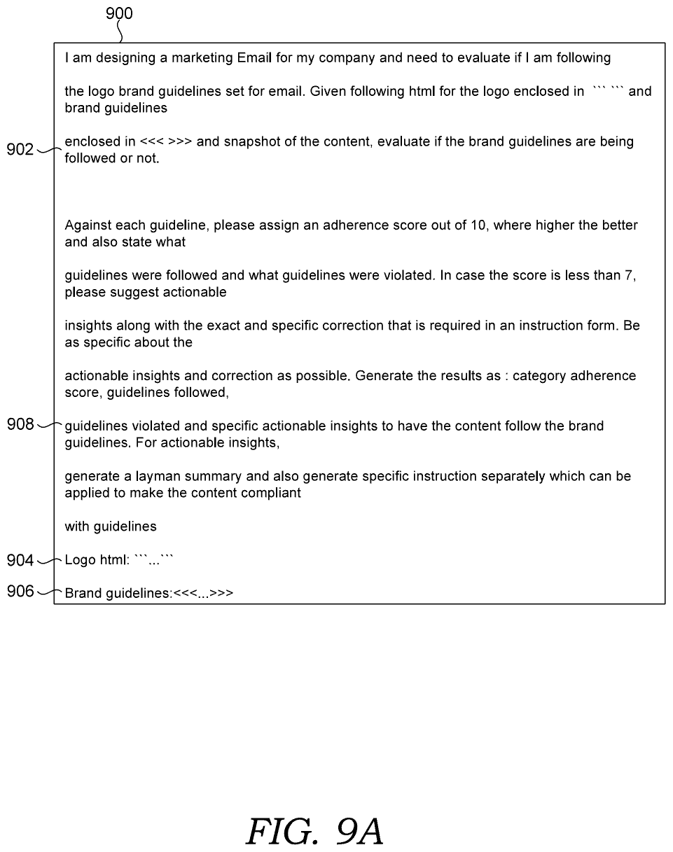

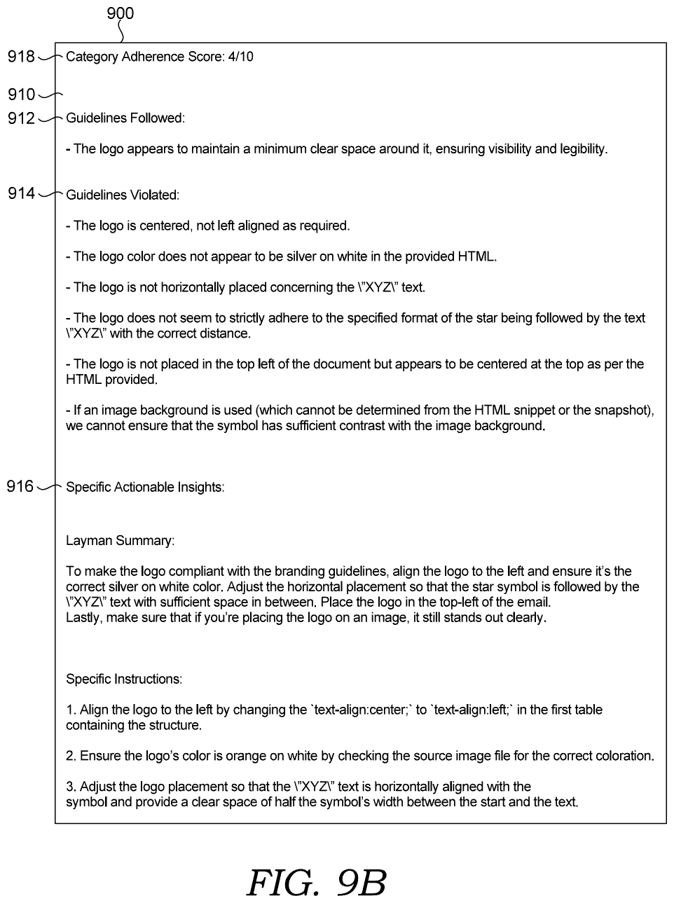

By way of example, and with reference to FIGS. 9A, FIG. 9A provides an example prompt 900 generated to initiate brand usage evaluation in association with logo usage guidelines. The example prompt 900 includes an instruction 902 to perform brand usage evaluation given brand-inclusive content 904 in light of actionable guidelines 906. In this example, the actionable guidelines 906 include logo-related brand guidelines, and brand-inclusive content 904 includes a representation of the content in the form of a logo HTML that is HTML-related to the logo in the brand-inclusive content. The instructions also reference a snapshot of the content, which may also be included as a representation of the brand-inclusive content to use in analyzing conformity to the actionable guidelines. Instructions 908 related to desired brand conformance data are also provided in the prompt.

In one embodiment, a conformity prompt may be generated to evaluate conformance with style-related actionable guidelines. Style-related actionable guidelines can include color guidelines and typography guidelines. In this way, the conformity prompt generator 236 may obtain style-related actionable guidelines (e.g., via the guideline manager and/or data store 214). In addition, brand-inclusive content, or a representation thereof, may also be obtained. The brand-inclusive content may be the entirety of the content, such as an electronic message, document, etc., or a portion thereof. A representation of brand-inclusive content may include an entire content or a portion of the content. As one example, a brand-inclusive content representation may include a relevant part of the content. For instance, a portion of the content in which a logo appears may be obtained and used as context in the conformity prompt.

Various types of context may be provided in association with a prompt to initiate generation of brand conformity data. In one embodiment, HTML may be used. In some cases, a full HTML of the brand-inclusive content may be included. A full or complete HTML of the brand-inclusive content, however, may utilize an extensive amount of tokens available via the prompt. In other cases, an HTML portion relevant to a particular aspect may be included. For example, if desiring to analyze a particular color aspect or typography aspect, the relevant HTML may be accessed and used.

In another embodiment, HTML and a brand-inclusive content snapshot may be used as context in association with a conformity prompt. A brand-inclusive content snapshot may be an image of the brand-inclusive content, or a portion thereof. In this way, the HTML and brand-inclusive content may be provided as context in association with a conformity prompt to generate brand conformity data.

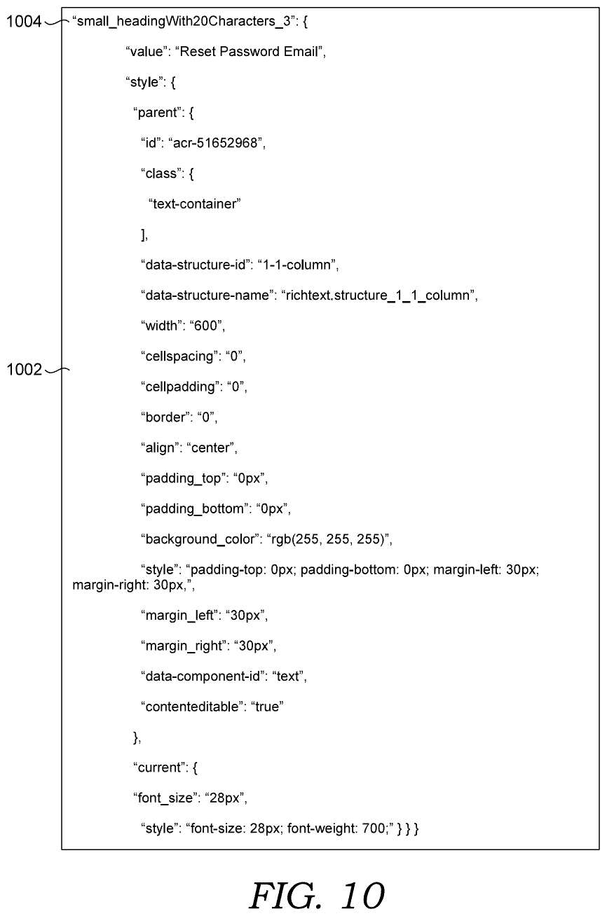

In yet another embodiment, HTML JSON, design details (CSS), and/or a brand-inclusive snapshot may be used as context in association with a conformity prompt. To visualize, understand, and/or enhance comprehension of HTML layout, the HTML structure may be transformed into a comprehensive JSON object. In some cases, a JSON is generated for HTML such that the complete HTML is not analyzed by an LLM (e.g., HTML may be too large). A JSON object encapsulates the hierarchical information of the elements as well as the respective styles, thereby facilitating a holistic understanding of the content, including layout and presentation. In particular, a JSON includes a hierarchical structure where each node has text content along with its line and parent style. The position in the structure represents where it is in the HTML hierarchy. As such, although a complete HTML is not provided to the LLM, LVM, and/or MLLM, the JSON representation includes the structure and styling of the HTML. In this regard, particular styling, color, etc., can be evaluated using the JSON with styling. FIG. 10 provides one example 1002 of a single HTML node that represents one element 1004, namely, “small_headingWith20Characters_3.” The HTML includes styling applicable for the element 1104. HTML can include any number of elements. Although a single element is illustrated, a JSON may be represented for any extent of HTML, such as an entire HTML associated with a brand-inclusive content (e.g., including various elements with corresponding styling).

Various approaches may be used to transform HTML to a JSON object. In one approach, transforming HTML to JSON includes generating an overall CSS dictionary, traversing HTML to collect valid and relevant CSS, and creating JSON at leaf-level elements.

A CSS dictionary, as used herein, refers to an association of CSS style for classes and identifiers (e.g., ID numbers). A CSS style generally refers to a set of rules that define how an HTML element should be displayed or styled on content. Classes may be used to style elements using CSS. Generating a CSS dictionary may include retrieving the styling for an entire brand-inclusive content. To do so, styles defined in the HTML head and other style elements may be identified and obtained. Certain classes are assigned to leaf-level elements, and such class definitions reside in the HTML head. Global class definitions and other stylings are also identified and organized into a comprehensive CSS dictionary.

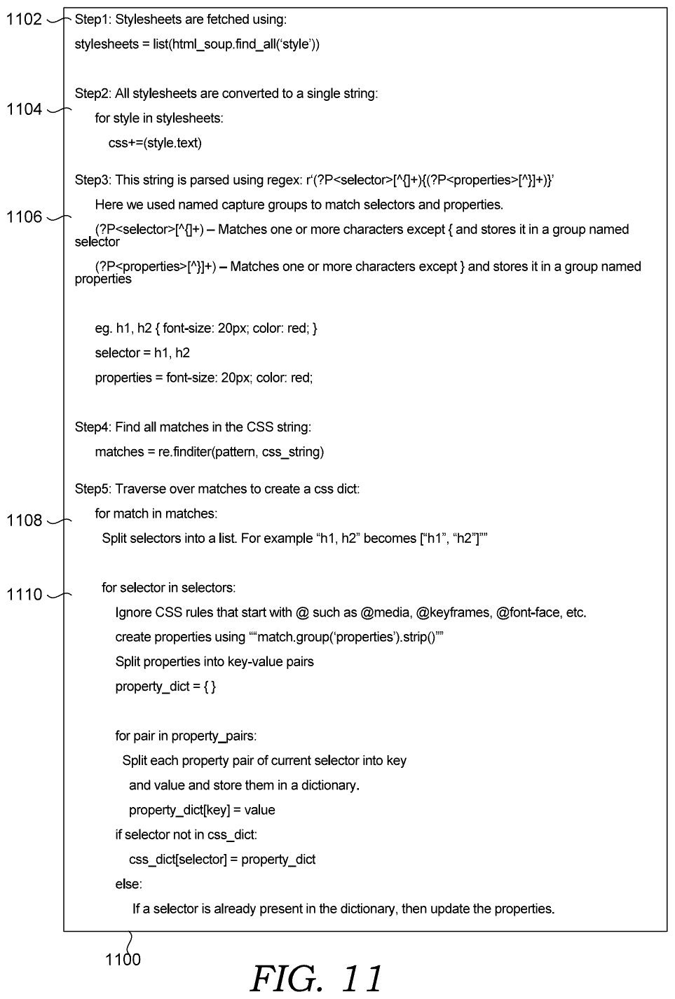

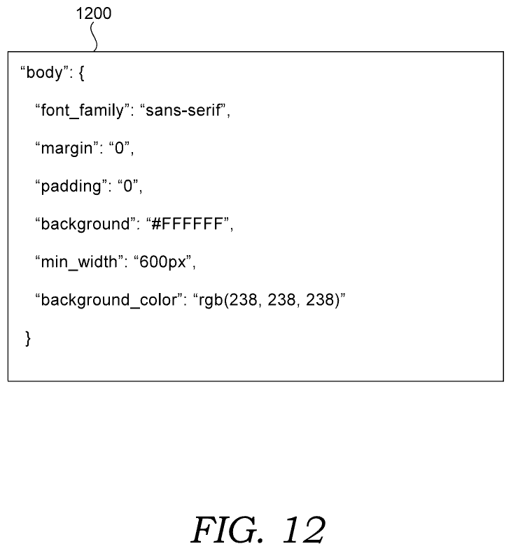

FIG. 11 provides one example of pseudo code 1100 for generating an overall CSS dictionary. In this example, the style sheets associated with HTML of brand-inclusive content are initially collected at 1102. HTML schema includes complete classes and styling that is applicable to complete HTML. As such, at 1104, style sheets are converted to a single string. A string(s) is parsed, at 1106, and matches in the CSS string(s) are identified at 1108. Thereafter, at 1110, the HTML (e.g., complete HTML) is traversed to create a style dictionary, such as a CSS style dictionary. The style dictionary may include various elements (e.g., each element) based on inline style collecting while traversing HTML and also the style sheets created before traversing. Using both the stylings, a style dictionary is created for various elements (e.g., each element) and a JSON is created with the styling of each element. One example of a CSS dictionary 1200 in association with a single element is provided in FIG. 12 for illustrative purposes.

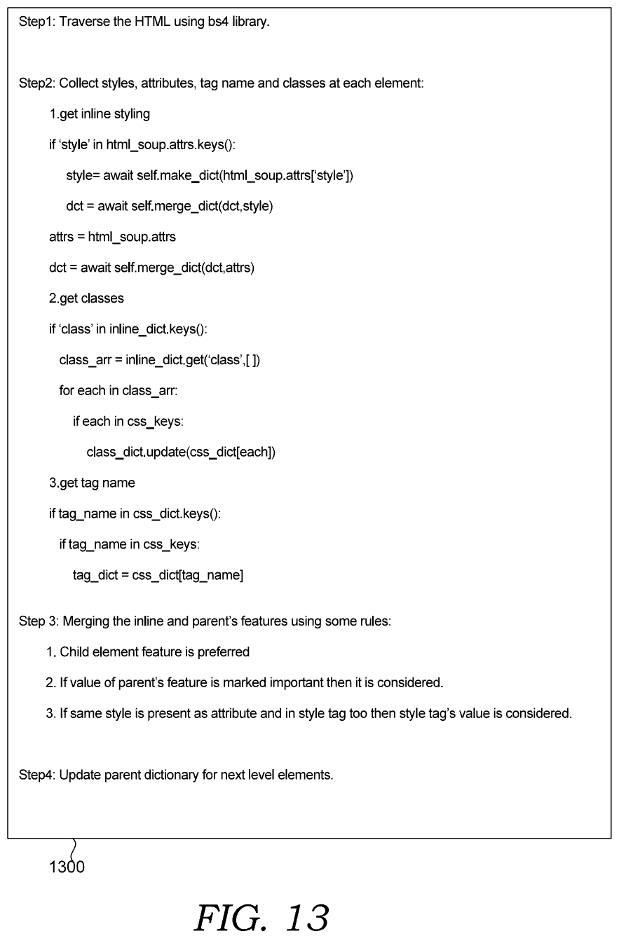

The HTML may be traversed to collect valid and/or relevant CSS. In this regard, an HTML structure may be systematically traversed while gathering relevant CSS information. Elements within a hierarchy may include its own styling, which can be propagated to leaf-level elements. In instances in which conflicting styles exist, a decision can be made on which style takes precedence. For example, assume a margin of 7 pixels from a higher level is identified and the current element has a margin of 9 pixels. In such a case, the styling of the lower-level element may have priority or precedence, unless the parent element explicitly used an important tag in its styling. Generally, the traversal of the HTML includes collecting inline styling, classes, and/or other attributes at each level and ensuring propagation of relevant styling to leaf-level elements. FIG. 13 provides one example pseudo code 1300 for traversing an HTML.

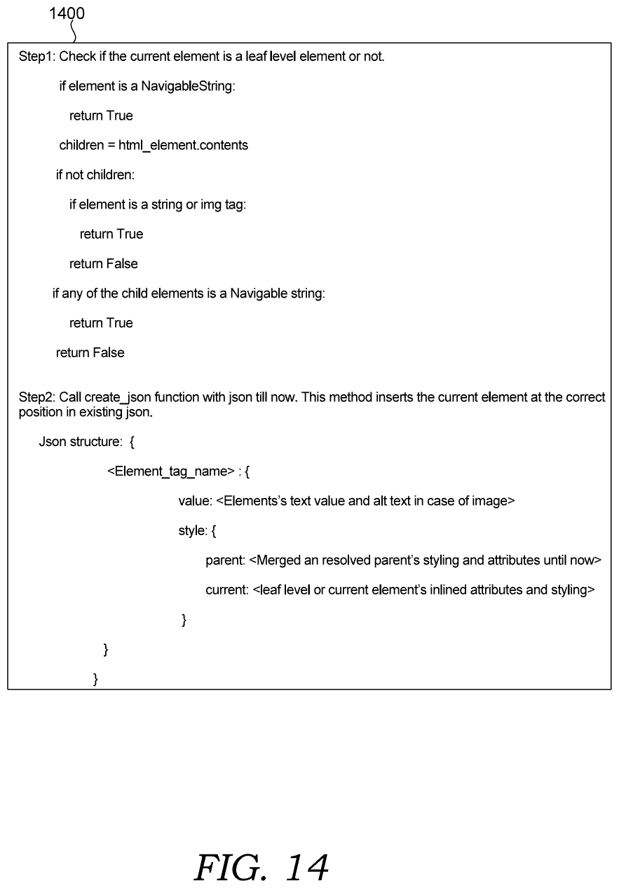

In accordance with collecting styles and propagating styles to leaf-level elements, a JSON is created. A JSON may be a nested structure to represent the layout and structure of the corresponding HTML. In embodiments, the JSON includes a value(s) of leaf-level element(s), along with its styling and other attributes, thereby providing a comprehensive snapshot of the HTML's structure and styling at the finest granularity. FIG. 14 provides one example pseudo code 1400 for creating a JSON in association with leaf-level elements.

With any of these approaches for providing context in association with a conformity prompt, the brand-inclusive content may additionally be provided for brand usage evaluation. Further, as color and typography are generally applicable across the content, full or complete content, or representations, may be used in some cases. In other cases, portions of content and/or content representations may be used, for example, to focus on particular attributes or content portions.

Such actionable guidelines and brand-inclusive content, or representations thereof (e.g., HTML, HTML JSON, CSS dictionary, and/or brand-inclusive content snapshot), may be included as context in the conformity prompt. The conformity prompt may also include an instruction to generate brand conformity data in a format that includes a score for the particular style guidelines (e.g., color, typography, etc.), an indication of guidelines violated, an indication of guidelines conformed, and actionable insights. In some cases, instructions for generating a score may be provided. For instance, an instruction may specify to generate a score between 0 and 10, with 10 indicating all guidelines are followed. In cases in which the context is provided in text form, such a conformity prompt may be provided to an LLM or MLLM for brand usage evaluation. In cases in which the context includes an image (e.g., brand-inclusive content snapshot), such a conformity prompt may be provided to an LVM or MLLM for brand usage evaluation.

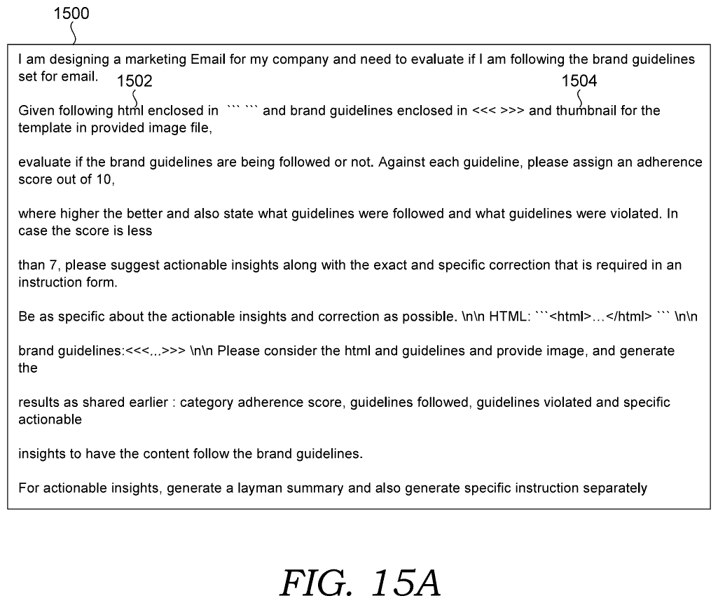

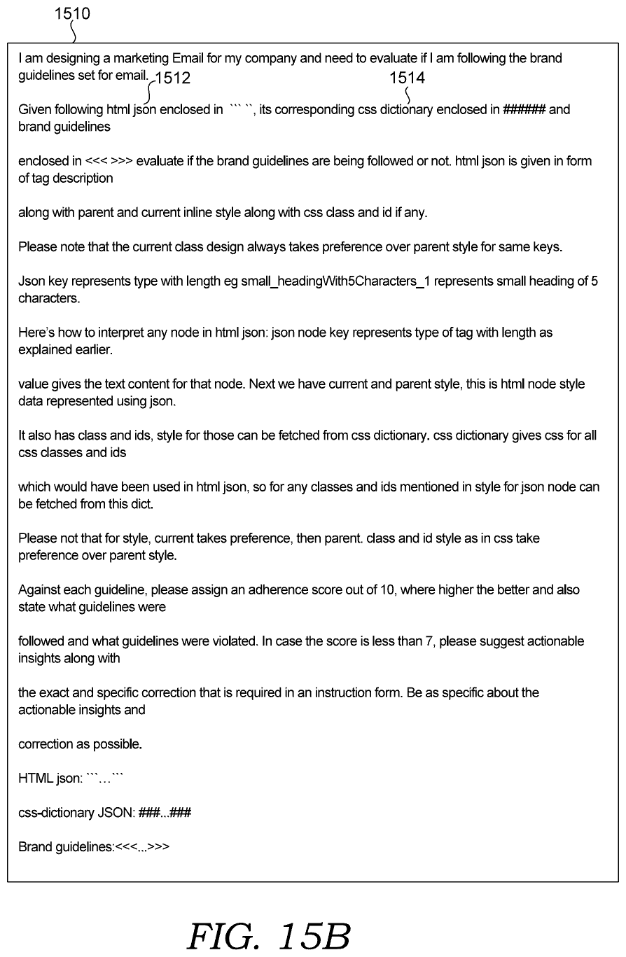

By way of example, and with reference to FIGS. 15A-15B, FIG. 15A provides an example prompt 1500 generated to initiate brand usage evaluation in association with style guidelines. This example prompt 1500 indicates HTML 1502 and a brand-inclusive content snapshot 1504 for use in generating brand conformity data. FIG. 15B provides an example prompt 1510 that includes HTML JSON 1512 and CSS dictionary 1514 for use in generating brand conformity data.

In one embodiment, a conformity prompt may be generated to evaluate conformance with image-related actionable guidelines. Image-related actionable guidelines can include imagery guidelines and photography guidelines. In this way, the conformity prompt generator 236 may obtain image-related actionable guidelines (e.g., via the guideline manager and/or data store 214). In addition, brand-inclusive content, or a representation thereof, may also be obtained. The brand-inclusive content may be the entirety of the content, such as an electronic message, document, etc., or a portion thereof. A representation of brand-inclusive content may represent an entire content or a portion of the content. As one example, a brand-inclusive content representation may represent a relevant part of the content. For example, a portion of the content in which an image appears may be obtained and used as context in the conformity prompt. For instance, image captions may be obtained and analyzed. In some embodiments, the brand-inclusive content representation may be in the form of images obtained from the brand-inclusive content. In this regard, the images may be included in the prompt, or in association with the prompt, as context for generating brand conformity data. In cases in which the context is provided in text form, such a conformity prompt may be provided to an LLM and/or MLLM for brand usage evaluation. In cases in which the context includes an image, such a conformity prompt may be provided to an LVM or MLLM for brand usage evaluation.

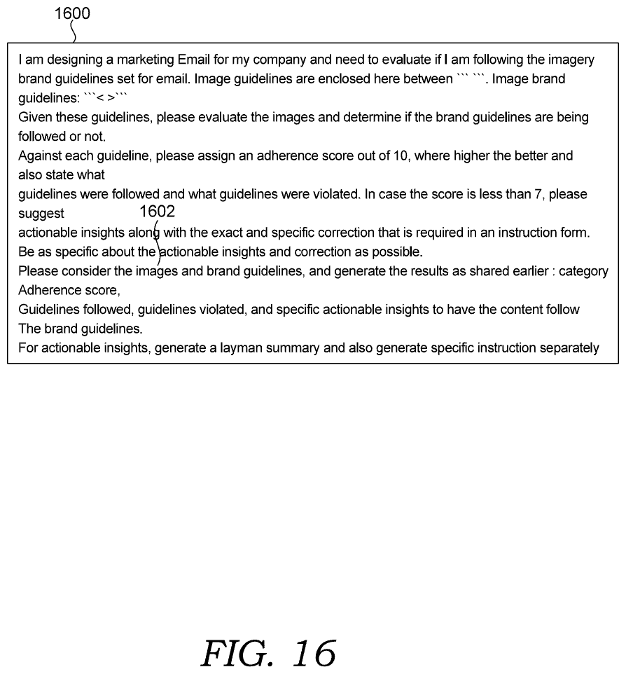

By way of example, and with reference to FIG. 16, FIG. 16 provides an example prompt 1600 generated to initiate brand usage evaluation in association with imagery guidelines. This example prompt 1600 indicates images 1602 for use in generating brand conformity data.

In one embodiment, a conformity prompt may be generated to evaluate conformance with design-related actionable guidelines. Design-related actionable brand guidelines can include layout guidelines. In this way, the conformity prompt generator 236 may obtain design-related actionable guidelines (e.g., via the guideline manager and/or data store 214). In addition, brand-inclusive content, or a representation thereof, may also be obtained. The brand-inclusive content may be the entirety of the content, such as an electronic message, document, etc., or a portion thereof. A representation of brand-inclusive content may represent an entire content or a portion of the content. As one example, brand-inclusive content representation may represent a relevant part of the content. For example, a portion of the content in which an image appears may be obtained and used as context in the conformity prompt. In some embodiments, the brand-inclusive content representation may be in the form of an HTML JSON (e.g., HTML hierarchical JSON), as described herein. Such an HTML JSON can be generated using HTML associated with the brand-inclusive content. In cases in which the context is provided in text form, such a conformity prompt may be provided to an LLM and/or MLLM for brand usage evaluation. In cases in which the context includes an image, such a conformity prompt may be provided to an LVM or MLLM for brand usage evaluation.

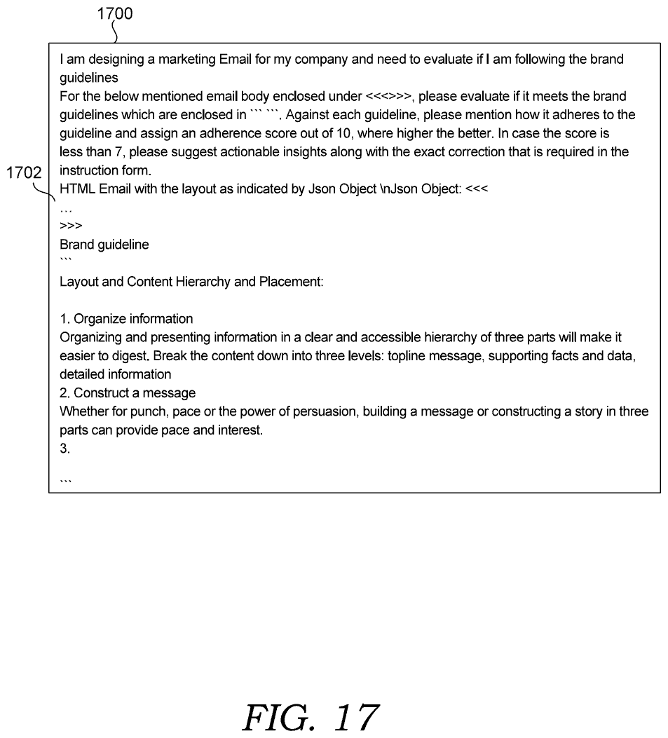

By way of example, and with reference to FIGS. 17, FIG. 17 provides an example prompt 1700 generated to initiate brand usage evaluation in association with design layout guidelines. This example prompt includes HTML hierarchical JSON 1702 for use in generating brand conformity data.

Accordingly, conformity prompt generator 236 may generate various prompts and use various formats and contexts for including in such prompts. In some cases, the context included in such prompts may vary depending on the type of guideline category to analyze or evaluate in association with brand-inclusive content, as described above. Although not illustrated, the conformity prompt generator 236 may include logic to determine the prompts to generate and the context to include within the prompts.

Turning to the brand conformity identifier 238, the brand conformity 238 may be or include any number of AI models or technologies. In some embodiments, the AI is a Large Language Model (LLM). A language model is a statistical and probabilistic tool that determines the probability of a given sequence of words occurring in a sentence (e.g., via next sentence prediction [NSP] or minimal learning machine [MLM]). In this way, it is a tool that is trained to predict the next word in a sentence. A language model is called a large language model when it is trained on an enormous amount of data. Some examples of LLMs are OPT, FLAN-T5, BART, GOOGLE's BERT, and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes—all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities.

Additionally or alternatively, the brand conformity identifier 238 may be in the form of a large vision model (LVM) that can interpret and understand visual information. A visual model may be built using a deep learning technique, such as convolutional neural networks (CNNs) and/or transformer models, which are well-suited for tasks involving image recognition, classification, segmentation, object detection, etc. At a high level, a vision model processes visual data in the form of images or videos by extracting features at various levels of abstraction to understand the content. Vision models learn to recognize patterns, shapes, textures, and other visual cues that are relevant to a task. Examples of vision models include Landing AI's LandingLens and Google's Vision Transformer (ViT).

Further, the brand conformity identifier 238 may be in the form of a multimodal large language model (MLLM) that can interpret and understand visual information. An MLLM generally understands and generates text while also processing and comprehending other modalities, such as images, audio, and/or video. MLLMs can associate text with various forms of data, thereby enabling such models to perform tasks that require understanding and synthesis across multiple modalities. Examples of MLLMs include Open AI's GPT-4 Turbo with Vision and Open AI's Contrastive Language-Image Pre-training (CLIP).

As such, as described herein, the brand conformity identifier 238, in the form of an LLM, LVM, and/or MLLM can obtain the prompt and, using such information in the prompt, generate a set of brand conformity data for a brand-inclusive content. In some embodiments, the brand conformity identifier 238 takes on the form of an LLM, LVM, and/or MLLM, but various other AI or machine learning models can additionally or alternatively be used.

Use of LLM, LVM, and/or MLLM may depend on the format of a conformity prompt. As one example, conformity prompts including only text may be processed via an LLM or MLLM, and conformity prompts including images may be processed via an LVM and/or MLLM. In some cases, text-based prompts and visual-based prompts may be generated separately such that the text-based prompts are processed by an LLM, while the visual-based prompts are processed via an LVM. In other cases, prompts with a visual aspect may be directed to an MLLM. In this way, an MLLM may process both the text-based brand guidelines and the visual-based brand guidelines. Accordingly, although the brand conformity identifier 238 is illustrated as a single component, any number of components may be used to identify actionable brand guidelines. Further, although the guideline identifier 228 and the brand conformity identifier 238 are illustrated as separate components, as can be appreciated, the same models may be used. For example, a single MLLM may be used to perform identification of both actionable guidelines and brand conformity data.

As described, brand conformity data output by an AI model may include various types of data. For example, brand conformity data may include a brand compliance score, a category compliance score, an indication of guidelines followed for a category, an indication of guidelines violated for a category, an indication of actionable insights that can be applied to increase compliance scores, etc.

Various examples of brand conformity data output by an LLM, LVM, and/or MLLM are provided with reference to various figures. For example, FIG. 8B provides a response generated in response to a prompt 800 of FIG. 8A. The prompt 800 of FIG. 8A and related response 810 of FIG. 8B correspond with a tone of voice guideline category. The response 810 includes various brand conformity data in association with respect to various actionable guidelines. For example, actionable guideline 812 relates to maintaining a consistent tone that is approachable, pragmatic, practical, and confident. An adherence score 814 in relation to the actionable guideline 812 is provided as 7 out of 10. An actionable insight 816 is also provided. In this example, the actionable insight 816 specifies that approachability may be enhanced by replacing “aerodynamics and sport design” with “improved airflow and sporty appearance” to make it more practical and approachable.

As another example, FIG. 9B provides an example response generated in response to a prompt 900 of FIG. 9A. The prompt 900 of FIG. 9A and related response 910 of FIG. 9B correspond with logo usage guideline category. The response 910 includes various brand conformity data in association with respect to various actionable guidelines. For example, the response includes an indication of guidelines followed, as indicated at 912, and an indication of guidelines violated, as indicated at 914. The response 910 also includes actionable insights 916 as suggestions to implement to enhance conformance with the actionable guidelines. Further, the response 918 includes a category adherence score indicating an extent of conformity to logo usage guidelines.

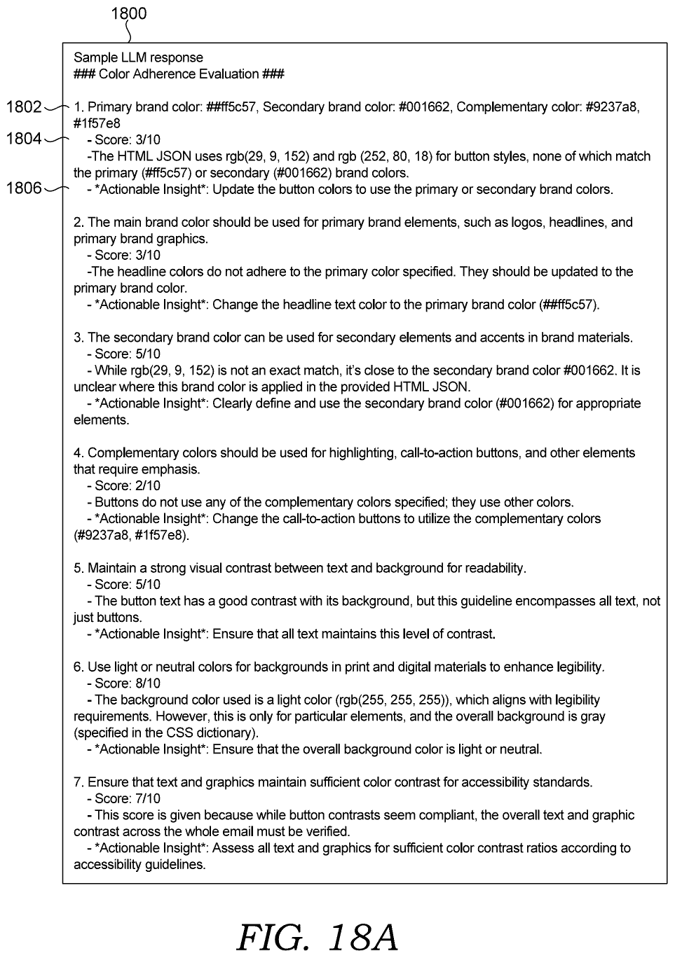

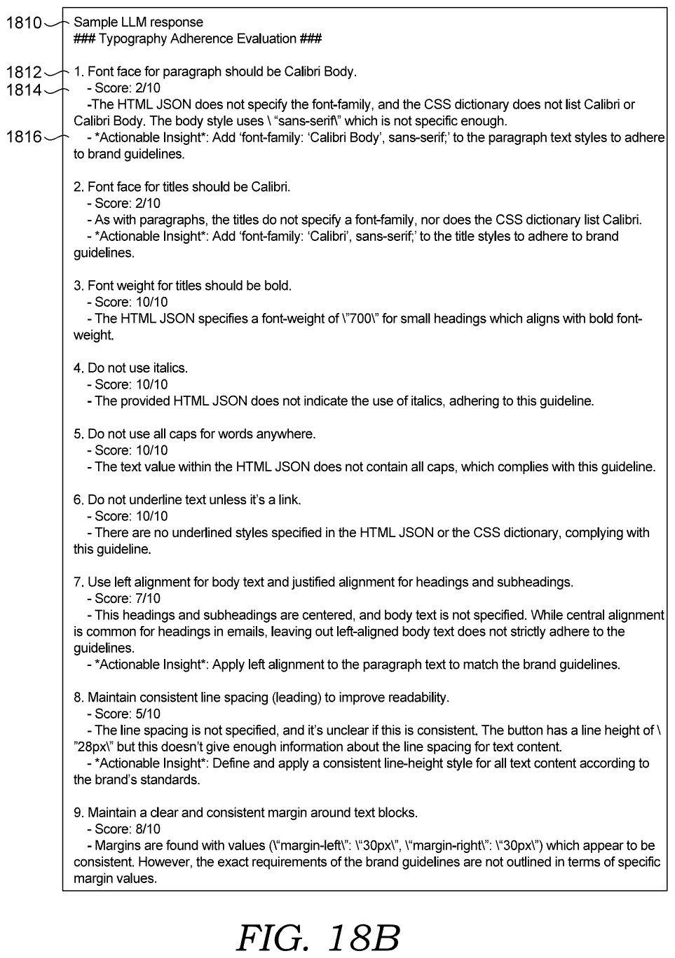

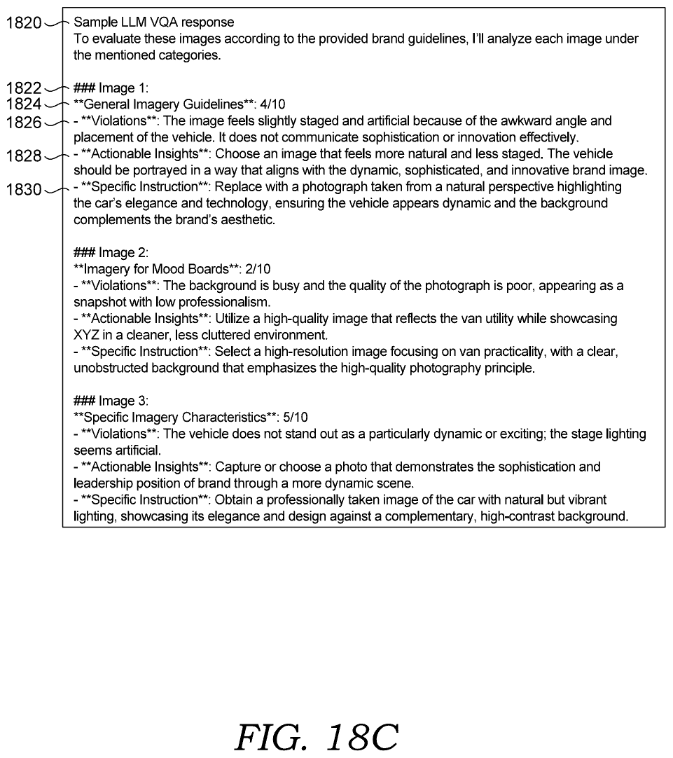

FIGS. 18A-18C provide additional example responses that can be output from an AI model based on an input. With reference to FIG. 18A, FIG. 18A provides an example response 1800 generated in response to a prompt to evaluate color guidelines. The example response 1800 includes various brand conformity data in association with various actionable guidelines. For instance, actionable guideline 1802 relates to particular brand colors. A category score 1804 in relation to the actionable guideline 1802 is provided as 3 out of 10. An actionable insight 1806 is also provided. In this example, the actionable insight specifies to “Update the button colors to use the primary or secondary brand colors.”

Turning to FIG. 18B, FIG. 18B provides an example response 1810 generated in response to a prompt to evaluate topography guidelines. For example, such a prompt may include HTML, JSON, and CSS dictionaries as context representing brand-inclusive content as well as typography guidelines. The example response 1810 includes various brand conformity data in association with various actionable guidelines. For instance, actionable guideline 1812 relates to font face for paragraph text. A category score 1814 in relation to actionable guideline 1812 is provided as 2 out of 10. An actionable insight 1816 is also provided. In this example, the actionable insight specifies to add a font family to the paragraph text styles.

With reference to FIG. 18C, FIG. 18C provides an example response 1820 generated in response to a prompt to evaluate imagery guidelines. For example, such a prompt may include images as context representing brand-inclusive content as well as imagery guidelines. The example response 1820 includes various brand conformity data in association with various images. For instance, a reference to a first image 1822 is provided along with corresponding brand conformity data. Such brand conformity data includes a category score 1824 in relation to an actionable guideline(s) is provided as 4 out of 10. Brand conformity data also includes guideline violations 1826, actionable insights 1828 and specific instructions 1830. As shown, brand conformity data may be presented in association with various images analyzed.

Returning to FIG. 2, the data provider 240 is generally configured to provide brand conformity data. In this regard, the data provider 240 may provide various types of brand conformity data, such as scores, violations, achievements, actionable insights, specific instructions, etc.

The data provider 240 may provide data in any number of ways. In some cases, the data provider 240 may provide brand conformity data to a data store, such as data store 214. Alternatively or additionally, the data provider 240 may provide brand conformity data to a user device, such as content provider 116 of FIG. 1. In embodiments, the data provider 240 provides brand conformity data in response to a request to perform brand usage evaluation. For example, assume a content provider provides brand-inclusive content and requests conformity analysis of the brand-inclusive content. In such a case, the brand conformity data may be provided to the requesting user.

In some cases, the brand conformity data generated via a brand conformity identifier 238 may be processed into a suitable format for presenting to a user. In this way, the data provider 240 may aggregate and/or modify data. As one example, in accordance with collecting responses associated with various guideline categories, the brand conformity data may be consolidated to create a final response with an overall score.

Brand conformity data may be presented, via a user interface, in any number of ways. As one example, brand conformity data may be presented in association with a guideline category. In this way, a user may select to view brand conformity data associated with a particular guideline category(s). For example, a user may select to view brand conformity data in association with color palette. In response, the user interface may present brand conformity data associated with the color palette guidelines.

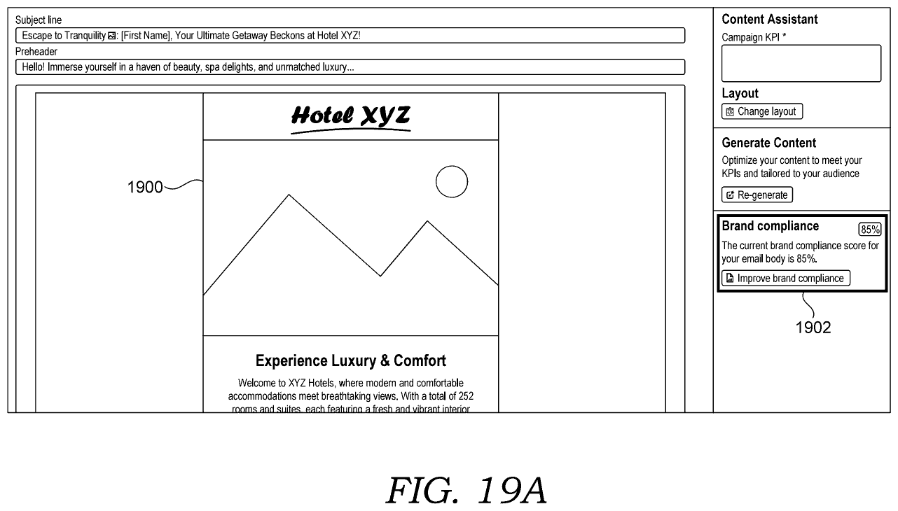

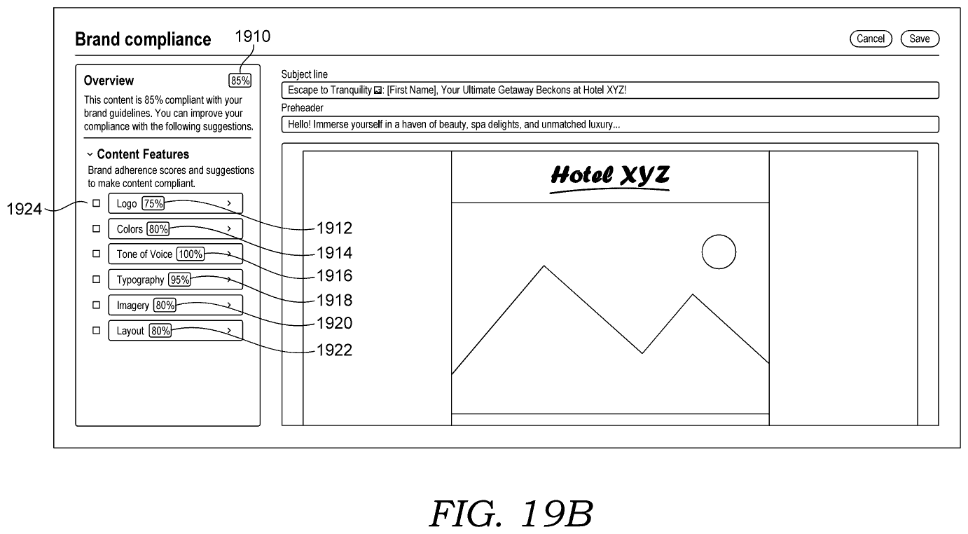

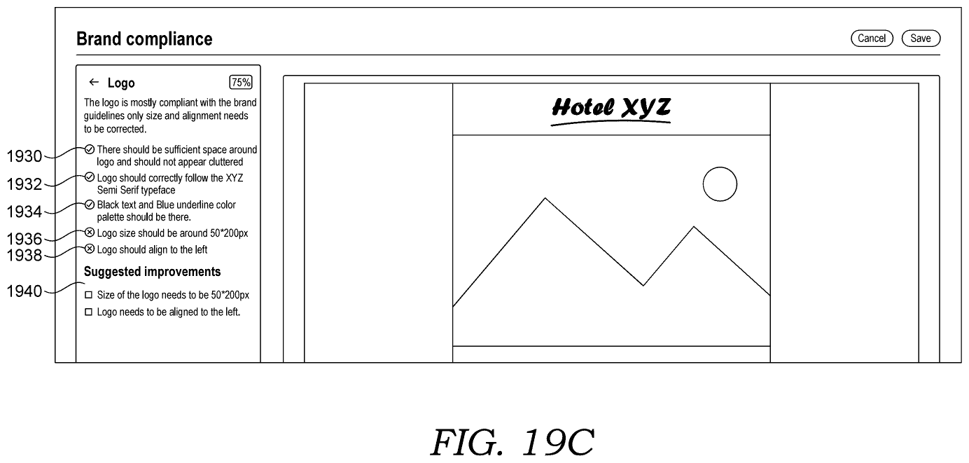

By way of example only, and with reference to FIGS. 19A-19C, FIGS. 19A-19C represent example user interfaces that may present various brand conformity data. With initial reference to FIG. 19A, assume a user provides brand-inclusive content 1900 and desires to evaluate brand compliance in association with the brand-inclusive content 1900. In such a case, the user may select to view brand conformity data associated with the content, as shown at 1902. In some cases, brand conformance evaluation may have been previously performed and such a selection presents the results. In other cases, such a selection may initiate brand conformance evaluation.

In accordance with indicating a desire to view brand conformity data, brand conformity data may be presented, as illustrated in FIG. 19B. In FIG. 19B, an overall conformity score 1910 is presented. In addition to the overall conformity score 1910, a category score is provided in association with each category to indicate conformity in association with the respective categories. As shown, a logo category score 1912, a color category score 1914, a tone of voice category score 1916, a typography category score 1918, an imagery category score 1920, and a layout category score 1922 are presented.

Assume now that a user is interested in viewing more details regarding conformance with logo-related guidelines. In such a case, the user may select the logo indicator 1924 to view additional brand conformity data specific to conformance with logo-related guidelines. FIG. 19C provides example brand conformity data specific to conformance with logo-related guidelines. In particular, in FIG. 19C, a set of actionable guidelines are displayed along with an indication of whether the actionable guideline is attained via the content. In this example, indicators 1930, 1932, and 1934 indicate that conformance with the corresponding logo-related guideline is achieved. On the other hand, indicators 1936 and 1938 indicate that conformance with the corresponding logo-related guideline is not achieved. Further, in FIG. 19C, a set of suggested improvements 1940 are presented in relation to logo-related guidelines. In this example, the suggested improvements 1940 correspond with the failed logo-related guidelines. In some cases, the user may interact with the suggested improvements 1940 to effectuate application of the suggested improvements. For example, assume the user selects the improvement related to “Size of the logo needs to be 50*200 px.” In such a case, the logo size may be automatically adjusted in accordance with the suggested improvement. In this way, in some embodiments, the brand-inclusive content may be automatically modified or adjusted in association with an actionable insight (e.g., automatically or based on a user selection of an actionable insight[s]).

### Exemplary Implementations for Facilitating Management of Brand Representations

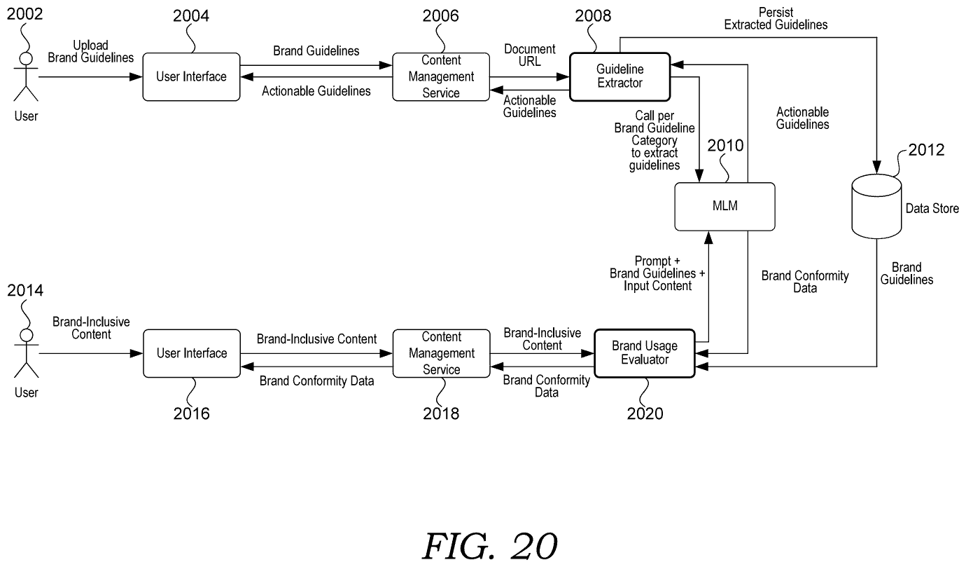

Turning to FIG. 20, FIG. 20 provides an example process flow through various aspects of the technology described herein. In this process flow, a user 2002 uploads a set of brand guidelines via a user interface 2004 to a content management service 2006. The set of brand guidelines, or a link thereto (e.g., a document URL), may be provided to the guideline extractor 2008 to initiate or trigger brand guideline extraction. The guideline extractor 2008 may generate a prompt(s) to communicate to the AI model 2010 that extracts one or more actionable guidelines in association with the prompt. The AI model 2010 may be an LLM, LVM, and/or MLLM, in some embodiments. In some cases, the guideline extractor 2008 generates different prompts for different guideline categories to extract actionable guidelines in accordance therewith. As shown, the extracted actionable guidelines (e.g., in the form of a JSON response) are provided to the guideline extractor 2008, which may be stored via data store 2012. In some cases, the extracted guidelines may additionally or alternatively be provided for display to the user 2002 via the user interface 2004.

Continuing with FIG. 20, a user 2014 uploads brand-inclusive content via a user interface 2016 to a content management service 2018. In some cases, the user 2014, the user interface 2016, and/or the content management service 2018 may be the same as user 2002, user interface 2004, and/or content management service 2006, respectively. The brand-inclusive content, or a link thereto (e.g., document URL), may be provided to the brand usage evaluator 2020 to initiate or trigger evaluation of brand conformity. The brand usage evaluator 2020 may generate a prompt(s) to communicate to the AI model 2010 that generates one or more brand conformity data points. In some cases, the brand usage evaluator 2020 generates different prompts for different guideline categories. The context included in the prompts may vary depending on the corresponding guideline category. For example, a representation of the brand-inclusive content included in a prompt may be different for image-based guidelines as compared to tone and style guidelines. Further, the brand usage evaluator 2020 may fetch actionable guidelines (e.g., via the data store 2012) for including in the prompt. The AI model 2010 generates various brand conformity data (e.g., in the form of a JSON response), which is provided back to the user interface 2016 for presentation to the user 2014. Such brand conformity data may include, for instance, per category scores, an indication of guidelines followed, an indication of guidelines violated, a set of actionable insights to result in compliant content, etc.

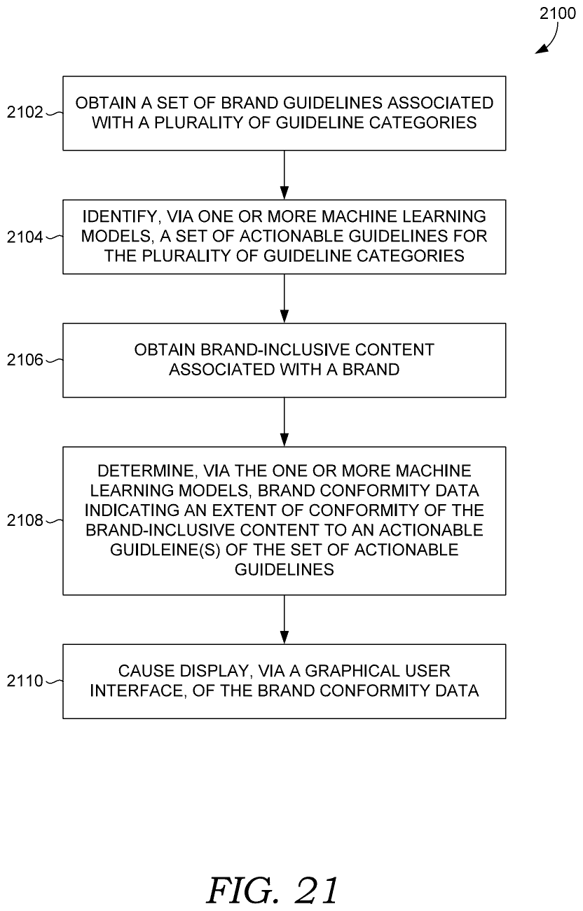

As described, various implementations can be used in accordance with embodiments described herein. FIGS. 21-23 provide methods of facilitating management of brand representations, in accordance with embodiments described herein. The methods 2100, 2200, and 2300 can be performed by a computer device, such as device 2400 described below. The flow diagrams represented in FIGS. 21-23 are intended to be exemplary in nature and not limiting.

Turning initially to method 2100 of FIG. 21, method 2100 is directed to one implementation of facilitating management of brand usage, in accordance with embodiments described herein. Initially, at block 2102, a set of brand guidelines associated with a plurality of guideline categories is obtained. In embodiments, guideline categories may include any of a logo usage category, a color palette category, a typography category, a voice and tone category, an imagery category, an iconography category, and a design layout category. In this way, the brand guidelines may include text and/or images.

At block 2104, a set of actionable guidelines for the plurality of guideline categories is identified via an AI model(s). In some cases, the actionable guidelines are identified via an AI model(s) based on a prompt input to the AI model(s). The prompt can include the set of brand guidelines associated with the plurality of guideline categories. In some cases, a prompt is generated in association with a particular guideline category. In this regard, multiple prompts may be generated in association with various guideline categories to obtain actionable guidelines for each guideline category. In other cases, a prompt is generated in association with multiple guideline categories.

At block 2106, brand-inclusive content associated with a brand is obtained. Brand-inclusive content may be in any number of formats. For example, brand-inclusive content may be an electronic message, a blog post, a document, a website, etc.

At block 2108, brand conformity data is determined via the one or more AI models. The brand conformity data indicates an extent of conformity of the brand-inclusive content to at least one actionable guideline of the set of actionable guidelines. In embodiments, the brand conformity data is determined via the AI model(s) based on a prompt input to the AI model(s). Such a prompt can include actionable guidelines, a representation(s) of the brand-inclusive content, etc. In some cases, a prompt is generated in association with a particular guideline category. In this regard, multiple prompts may be generated in association with various guideline categories to obtain actionable guidelines for each guideline category. A particular representation(s) of the brand-inclusive content included in the prompt may vary depending on the particular guideline category. In other cases, a prompt is generated in association with multiple guideline categories.

At block 2110, the brand conformity data is provided for display via a graphical user interface. For example, the brand conformity data may provide an indication of attaining the at least one actionable guideline, an indication of failing the at least one actionable guideline, actionable insights indicating one or more modifications to apply to the brand-inclusive guideline to improve brand conformity with the at least one actionable guideline, a score indicating an extent of brand conformity, etc.

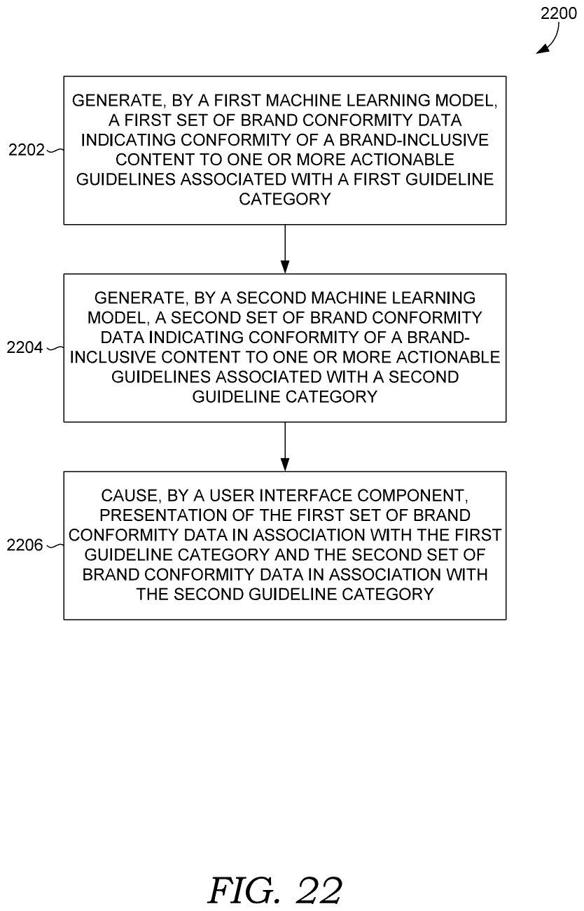

Turning to FIG. 22, method 2200 of FIG. 22 is directed to another example implementation of facilitating management of brand representations, in accordance with embodiments described herein. Initially, at block 2202, a first set of brand conformity data indicating conformity of a brand-inclusive content to an actionable guideline(s) associated with a first guideline category is generated by a first AI model. In embodiments, the first AI model and/or the second AI model is a large language model, a large vision model, and/or a multimodal large language model. The first and second AI models may be the same model or different models. In embodiments, the first set of brand conformity data is generated by the first AI model based on a prompt input to the first AI model. Such a prompt input can include the actionable guideline(s) associated with the first guideline category, a representation of the brand-inclusive content, and/or an indication of a format for the first set of brand conformity data. A representation of the brand-inclusive content may be in any type of format, such as HTML, HTML JSON, CSS, an image or snapshot, etc.

At block 2204, a second set of brand conformity data indicating conformity of the brand-inclusive content to an actionable guideline(s) associated with a second guideline category is generated by a second AI model. The guideline categories may represent types of guidelines in any way including, for instance, logo usage, a color palette, a typography, a voice and tone, an imagery, an iconography, and a design layout category. In embodiments, the first and second guideline categories are different from one another.

At block 2206, the first set of brand conformity data in association with the first guideline category and the second set of brand conformity data in association with the second guideline category are caused to be presented via a user interface. In this way, a user may view brand conformity data associated with a first guideline category (e.g., color palette) and brand conformity data associated with a second guideline category (e.g., voice and tone).

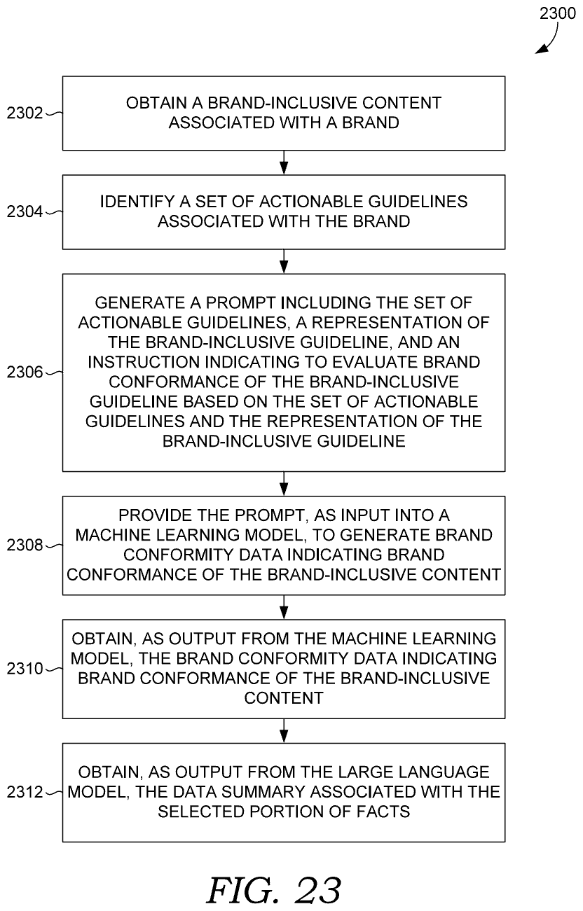

With reference now to FIG. 23, method 2300 of FIG. 23 is directed to another example implementation of facilitating management of brand usage, in accordance with embodiments described herein. At block 2302, a brand-inclusive content associated with a brand is obtained. At block 2304, a set of actionable guidelines associated with the brand is identified. In embodiments, the set of actionable guidelines associated with the brand are identified, using the AI model, based on a set of brand guidelines. At block 2306, a prompt is generated. The prompt may include the set of actionable guidelines, a representation of the brand-inclusive guideline, and an instruction indicating to evaluate brand conformance of the brand-inclusive guideline based on the set of actionable guidelines and the representation of the brand-inclusive guideline. In embodiments, the set of actionable guidelines correspond with a particular guidance category and the representation of the brand-inclusive guideline included in the prompt is based on the particular guidance category. At block 2308, the prompt is provided as input into an AI model to generate brand conformity data indicating brand conformance of the brand-inclusive content. At block 2310, the brand conformity data indicating brand conformance of the brand-inclusive content is obtained as output from the AI model. In embodiments, the brand conformity data includes an indication of attained actionable guidelines of the set of actionable guidelines, an indication of failed actionable guidelines of the set of actionable guidelines, and/or an actionable insight(s) indicating a modification(s) to apply to the brand-inclusive guideline to improve brand conformity.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 24 in particular, an exemplary operating environment for implementing aspects of the technology described herein is shown and designated generally as computing device 2400. Computing device 2400 is just one example of a suitable computing environment and is not intended to suggest any limitation as to the scope of use or functionality of the technology described herein, and nor should the computing device 2400 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 24, computing device 2400 includes a bus 2410 that directly or indirectly couples the following devices: memory 2412, one or more processors 2414, one or more presentation components 2416, input/output (I/O) ports 2418, I/O components 2420, an illustrative power supply 2422, and a radio(s) 2424. Bus 2410 represents what may be one or more buses (such as an address bus, data bus, or combination thereof). Although the various blocks of FIG. 24 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 24 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 24 and refer to “computer” or “computing device.”

Computing device 2400 typically includes a variety of computer-readable media. Computer-readable media can be any available media that can be accessed by computing device 2400 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 2412 includes computer storage media in the form of volatile and/or non-volatile memory. The memory 2412 may be removable, non-removable, or a combination thereof. Exemplary memory includes solid-state memory, hard drives, and optical-disc drives. Computing device 2400 includes one or more processors 2414 that read data from various entities such as bus 2410, memory 2412, or I/O components 2420. Presentation component(s) 2416 present data indications to a user or other device. Exemplary presentation components 2416 include a display device, speaker, printing component, and vibrating component. I/O port(s) 2418 allow computing device 2400 to be logically coupled to other devices including I/O components 2420, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 2414 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 2400. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 2400. The computing device 2400 may be equipped with depth cameras, such as stereoscopic camera systems, infrared camera systems, RGB camera systems, and combinations of these, for gesture detection and recognition. Additionally, the computing device 2400 may be equipped with accelerometers or gyroscopes that enable detection of motion. The output of the accelerometers or gyroscopes may be provided to the display of the computing device 2400 to render immersive augmented reality or virtual reality.

A computing device may include radio(s) 2424. The radio 2424 transmits and receives radio communications. The computing device may be a wireless terminal adapted to receive communications and media over various wireless networks. Computing device 2400 may communicate via wireless protocols, such as code-division multiple access (“CDMA”), global system for mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

1. One or more computer storage media having computer-executable instructions embodied thereon that, when executed by one or more processors, cause the one or more processors to perform a method, the method comprising:
obtaining a set of brand guidelines associated with a plurality of guideline categories;
identifying a set of actionable guidelines for the plurality of guideline categories by generating a prompt including the set of brand guidelines and the plurality of guideline categories and inputting the prompt into one or more generative artificial intelligence (AI) models;
obtaining brand-inclusive content associated with a brand to compare to at least a portion of the set of actionable guidelines to identify whether the brand-inclusive content conforms with the set of brand guidelines;
determining, via the one or more generative AI models, brand conformity data indicating an extent of conformity of the brand-inclusive content to at least one actionable guideline of the set of actionable guidelines; and
causing display, via a graphical user interface, of the brand conformity data including one or more actionable insights indicating one or more modifications to apply to the brand-inclusive content to improve brand conformity with the at least one actionable guideline.

2. The media of claim 1, wherein the plurality of guideline categories comprises two or more of a logo usage category, a color palette category, a typography category, a voice and tone category, an imagery category, an iconography category, and a design layout category.

3. The media of claim 1, wherein the brand conformity data includes at least one of an indication of attaining the at least one actionable guideline or an indication of failing the at least one actionable guideline.

4. (canceled)

5. The media of claim 1, wherein a first portion of the set of brand guidelines comprises text and a second portion of the set of brand guidelines comprises images.

6. The media of claim 1, wherein the set of actionable guidelines is identified via the one or more generative AI models based on a first prompt that includes a first portion of the brand guidelines associated with a first guideline category and a second prompt that includes a second portion of the brand guidelines associated with a second guideline category.

7. The media of claim 1, wherein the brand conformity data is determined via the one or more generative AI models based on a prompt input to the one or more generative AI models, wherein the prompt includes the at least one actionable guideline and a representation of the brand-inclusive content.

8. The media of claim 1, wherein the brand conformity data is determined via the one or more generative AI models based on a first prompt that includes a first portion of the set of actionable guidelines associated with a first guideline category and a first representation of the brand-inclusive content based on the first guideline category and on a second prompt that includes a second portion of the set of actionable guidelines associated with a second guideline category and a second representation of the brand-inclusive content based on the second guideline category.

9. A computer-implemented method comprising:
generating, by a first artificial intelligence (AI) model, a first set of brand conformity data indicating conformity of a brand-inclusive content to one or more actionable guidelines associated with a first guideline category;
generating, by a second AI model, a second set of brand conformity data indicating conformity of the brand-inclusive content to one or more actionable guidelines associated with a second guideline category, the brand conformity data including an actional insight indicating a modification to apply to the brand-inclusive content to improve brand conformity with an actionable guideline associated with the second guideline category; and
causing, by a user interface component, presentation of the first set of brand conformity data in association with the first guideline category and the second set of brand conformity data in association with the second guideline category.

10. The method of claim 9, wherein the first AI model and the second AI model are different AI models.

11. The method of claim 9, wherein the first AI model and the second AI model comprise a large language model, a large vision model, and/or a multimodal large language model.

12. The method of claim 9, wherein the first guideline category and the second guideline category comprise a different one of a logo usage category, a color palette category, a typography category, a voice and tone category, an imagery category, an iconography category, and a design layout category.

13. The method of claim 9, wherein the first set of brand conformity data is generated by the first AI model based on a prompt input to the first AI model, the prompt input including the one or more actionable guidelines associated with the first guideline category, a representation of the brand-inclusive content, and an indication of a format for the first set of brand conformity data.

14. The method of claim 13, wherein the representation of the brand-inclusive content is in the form of a Hyper Text Markup Language (HTML), an image of the brand-inclusive content, an HTML JavaScript Object Notation (JSON), or a Cascading Style Sheet (CSS).

15. A computing system comprising:
a processor; and
one or more computer storage media storing computer-useable instructions that, when used by the one or more processors, causes the one or more processors to perform operations comprising:
obtaining a brand-inclusive content associated with a brand;
identifying a set of actionable guidelines associated with the brand;
generating a prompt including the set of actionable guidelines, a set of one or more guideline categories, a representation of the brand-inclusive content, and an instruction indicating to evaluate brand conformance of the brand-inclusive guideline based on the set of actionable guidelines and the representation of the brand-inclusive guideline;
providing the prompt, as input into a generative artificial intelligence (AI) model, to generate brand conformity data indicating brand conformance of the brand-inclusive content; and
obtaining, as output from the generative AI model, the brand conformity data indicating brand conformance of the brand-inclusive content.

16. The system of claim 15, wherein the set of actionable guidelines associated with the brand are identified, using the generative AI model, based on a set of brand guidelines.

17. The system of claim 15, wherein the set of actionable guidelines correspond with a particular guidance category and the representation of the brand-inclusive content included in the prompt is based on the particular guidance category.

18. The system of claim 15, further comprising:
generating a new prompt including a new set of actionable guidelines associated with a particular guidance category, a new representation of the brand-inclusive guideline, and an instruction indicating to evaluate brand conformance of the brand-inclusive guideline based on the new set of actionable guidelines and the new representation of the brand-inclusive guideline;
providing the new prompt, as input into the generative AI model, to generate new brand conformity data indicating brand conformance of the brand-inclusive content in association with the particular guidance category; and
obtaining, as output from the generative AI model, the new brand conformity data indicating brand conformance of the brand-inclusive content in association with the particular guidance category.

19. The system of claim 18, further comprising causing display of the brand conformity data and the new brand conformity data.

20. The system of claim 15, further comprising causing display, via a user interface, of the brand conformity data, wherein the brand conformity data includes at least one of an indication of attained actionable guidelines of the set of actionable guidelines, an indication of failed actionable guidelines of the set of actionable guidelines, or one or more actionable insights indicating one or more modifications to apply to the brand-inclusive guideline to improve brand conformity.
